(19) United States
(12) Patent Application Publication
(10) Pub. No.: US 2024/0314677 A1
(43) Pub. Date: Sep. 19, 2024

(54) First Core Network Node, Second Node and Third Node, Communications System and Methods Performed, Thereby for Handling Performance of an Action By a Device

(71) Applicant: Telefonaktiebolaget LM Ericsson (PUBL), Stockholm (SE)

(72) Inventors: Miguel Angel MUN˜OZ DE LA TORRE ALONSO, Madrid (ES); Maria Luisa MAS ROSIQUE, Tres Cantos (ES); Marcus IHLAR, Älvsjö (SE)

(21) Appl. No.: 18/578,241

(22) PCT Filed: Sep. 20, 2021
(86) PCT No.: PCT/EP2021/075827

§ 371 Date: Jan. 10, 2024

(30) Foreign Application Priority Data
Jul. 12, 2021 (EP) 21382627.4

(51) Int. Cl. H04W 48/16; H04W 48/18

(52) U.S. Cl. CPC H04W 48/16; H04W 48/18

(57) ABSTRACT

A computer-implemented method, performed by a first core network node (111), for handling performance of an action by a device (130). The device (130) operates in the communications system (100) via a connection through a data session. The first core network node (111) sets (406), based on a determination that the device (130) is to perform an action with the communications system (100), a captivity state of the device (130) to a captive state. The captive state indicates that the device (130) has not yet performed the action. The first core network node (111) also provides (407) an indication to a second node (112). The second node (112) manages, via a first application programming interface, a third node (113). The third node (113) manages a captivity portal accessible by the device (130) to perform the action. The indication indicates the state of the device (130) has been set to captive state for the action.

### TECHNICAL FIELD

The present disclosure relates generally to a first core network node and methods performed thereby for handling performance of an action by a device. The present disclosure also relates generally to a second node, and methods performed thereby, for handling performance of the action by the device. The present disclosure also relates generally to a third node, and methods performed thereby for handling performance of the action by the device. The present disclosure further relates generally to a communications system and methods performed thereby for handling performance of the action by the device.

### BACKGROUND

Computer systems in a communications network may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-UTRA, as well as a Fifth Generation (5G) Packet Core Network, which may be referred to as 5G Core Network, abbreviated as 5GC.

A 3GPP system comprising a 5G Access Network (AN), a 5G Core Network and a UE may be referred to as a 5G system.

FIG. 1 is a schematic diagram depicting a particular example of a 5G reference architecture as defined by 3GPP, which may be used as a reference for the present disclosure. An Application Function (AF) 1 may interact with the 3GPP Core Network through a Network Exposure Function (NEF) 2. In case the AF 1 is trusted, e.g., internal to the network operator, the AF may interact with the 3GPP Core Network directly, with no NEF 2 involved. The NEF 2 may support different functionality, e.g., different Exposure Application Program Interfaces (APIs). The Unified Data Repository (UDR) 3 may store data grouped into distinct collections of subscription-related information: subscription data, policy data, structured data for exposure, and application data. The Charging Function (CHF) 4 may support charging related functionality, specifically online and offline charging. The Policy Control Function (PCF) 5 may support a unified policy framework to govern the network behavior. Specifically, the PCF 5 may provide Policy and Charging Control (PCC) rules to the Policy and Charging Enforcement Function (PCEF), that is, the Session Management Function (SMF)/User Plane function (UPF) that may enforce policy and charging decisions according to provisioned Policy and Charging Control (PCC) rules. The Session Management Function (SMF) 6 may support different functionalities, e.g., may receive PCC rules from the PCF 5 and may configure the UPF 7 accordingly. The UPF 7 may support handling of user plane traffic based on the rules received from the SMF 6, e.g. packet inspection and different enforcement actions such as reporting for charging and Quality of Service (QoS) handling. The PCF 3 may provide policy rules to a UE through the Access and Mobility Function (AMF) 8. The AMF 8 may manage access of the UE. For example, when the UE may be connected through different access networks, and mobility aspects of the UE. Also depicted in FIG. 1 are a Network Data Analytics Function (NWDAF) 9. Each of the UDR 3, the NEF 2, the NWDAF 9, the AF 1, the PCF 5, the CHF 4, the AMF 8, the SMF 6 and the UPF 7 may have an interface through which they may be accessed, which as depicted in the Figure, may be, respectively: Nudr 11, Nnef 12, Nnwdaf 13, Naf 14, Npcf 15, Nchf 16, Namf 17, Nsmf 18 and N4 5.

Internet Engineering Task Force (IETF) Captive Portal (CAPPORT) CAPPORT may be understood as a new standard, e.g., as defined by IETF in [1] [2] [3], that may allow access points to advertise that they are “captive” when a device first joins, rather than rely on traffic interception.

Originally, Android and iOS included detection of Captive portals using cleartext HTTP probes. If the probe received an HTTP redirect, the device assumed that the network was a captive portal. As there is no standard URL to probe, this technique may be unreliable, since such probes could be mistakenly allowed or blocked, instead of redirected.

The new CAPPORT Application Program Interface (API) may allow portals to provide a positive signal that login is required, along with a Uniform Resource Locator (URL) to log into.

### Traffic Encryption and Network Management

Traffic encryption is growing significantly in mobile networks and at the same time, the encryption mechanisms are growing in complexity. In particular, most applications today may not be based on Hypertext Transport Protocol (HTTP) cleartext, but instead they may be based on Hypertext Transport Protocol Secure (HTTPS) using Transport Layer Security (TLS). Additionally, a significant part of the traffic may be based on Quick UDP Internet Connection (QUIC) transport, which may be understood to have an encryption level higher than TLS. In the future, it is foreseen that most apps will be based on QUIC transport.

Given the rising trend in traffic encryption, existing methods to send notifications to devices operating in a network may not be possible, or may not be reliable, thereby hindering the provision of telecommunication services in the communications network.

### SUMMARY

As part of the development of embodiments herein, one or more challenges with the existing technology will first be identified and discussed.

Mobile Network operators today may apply different traffic management actions, one of them being user notification, which may be supported in a UPF as traffic redirection, e.g., HTTP based redirection, in order to notify the user e.g., when the subscriber's quota may be expired, potentially on a per application basis, or when the network may want to notify the user of any event, e.g., user entering roaming, which may be subject to extra charging. HTTP based redirection may have the following issues. First, it is currently not possible for a UPF to apply redirection for HTTPS traffic, e.g., HTTP/HTTP2 over TLS. The same happens for QUIC based applications e.g., HTTP3 over QUIC, such as YouTube. Second, because most applications today are encrypted, e.g., with HTTPS/TLS or QUIC, and for those, redirection in the UPF is not possible. In addition, Domain Name System (DNS) traffic may be encrypted, e.g., DNS over HTTPS (DoH) or DNS over TLS (DoT), so it is not even possible to trigger redirection based on DNS inspection at the UPF. Third, HTTP based redirection cannot be applied to applications which are not based on HTTP. And fourth, browsers may support HTTP redirection, but some Applications do not support it, e.g., they may ignore the HTTP 3xx message triggered by UPF.

Short Messaging System (SMS), or e-mail, based notifications may have the following issues. First, the user may ignore the SMS, or e-mail, notifications at exhaustion of data bundle, and may not be able to easily purchase or renew their data bundle.

Therefore, it is an object of embodiments herein to improve the handling of performance of an action by a device in a communications system. Particularly, it is an object of embodiments herein to improve the handling of performance of an action by a device operating in the communications system via a connection through a data session.

According to a first aspect of embodiments herein, the object is achieved by a computer-implemented method, performed by a first core network node. The method is for handling performance of an action by a device. The first node operates in a communications system. The device operates in the communications system via a connection through a data session. The first core network node sets, based on a determination that the device is to perform an action with the communications system, a captivity state of the device to a captive state. The captive state indicates that the device has not yet performed the action. The first node then provides an indication to a second node operating in the communications system. The second node manages, via a first application programming interface, a third node operating in the communications system. The third node manages a captivity portal accessible by the device to perform the action. The indication indicates the state of the device has been set to captive state for the action.

According to a second aspect of embodiments herein, the object is achieved by a computer-implemented method, performed by the second node. The method is for handling performance of the action by the device. The second node operates in the communications system. The device operates in the communications system via the connection through the data session. The second node obtains the indication from the first core network node operating in the communications system. The second node manages, via the first application programming interface, the third node operating in the communications system. The third node manages the captivity portal accessible by the device to perform the action. The indication indicates the state of the device has been set to captive state for the action. The captive state indicates that the device has not yet performed the action. The second node then send provides, based on the obtained indication, the additional indication to or towards the device. The additional indication indicates to the device to contact the third node to perform the action via the captivity portal.

According to a third aspect of embodiments herein, the object is achieved by a computer-implemented method, performed by the third node. The method is for handling performance of the action by the device. The third node operates in the communications system. The device operates in the communications system via the connection through the data session. The third node obtains a further indication from the first core network node operating in the communications system. The further indication indicates the action to be performed by the device via the captivity portal managed by the third node and accessible by the device to perform the action. The further indication is provided via the second service-based interface. The third node also facilitates, based on the obtained further indication, performance of the action by the device via the captivity portal.

According to a fourth aspect of embodiments herein, the object is achieved by a computer-implemented method, performed by a communications system. The method is for handling performance of the action by the device. The communications system the first core network node, the second node and the third node. The device operates in the communications system via the connection through the data session. The method comprises setting, by the first core network node, based on a determination that the device is to perform an action with the communications system, the captivity state of the device to the captive state. The captive state indicates that the device has not yet performed the action. The method also comprises providing, by the first core network node, the indication to the second node. The second node manages, via the first application programming interface, the third node. The third node operates in the communications system. The third node 113 manages a captivity portal accessible by the device to perform the action. The indication indicates the state of the device has been set to captive state for the action. The method then comprises obtaining, by the second node, the indication from the first core network node. The method also comprises providing, by the second node, based on the obtained indication, the additional indication to or towards the device. The additional indication indicates to the device to contact the third node to perform the action via the captivity portal. The method also comprises obtaining, by the third node, the further indication from the first core network node. The further indication indicates the action to be performed by the device via the captivity portal managed by the third node and accessible by the device to perform the action. The further indication is provided via the second service-based interface. The method additionally comprises facilitating, by the third node, based on the obtained further indication, performance of the action by the device via the captivity portal.

According to a fifth aspect of embodiments herein, the object is achieved by the first core network node, for handling performance of the action by the device. The first node is configured to operate in the communications system. The device is configured to operate in the communications system via the connection through the data session. The first node is further configured to set, based on the determination that the device is to perform the action with the communications system, the captivity state of the device to the captive state. The captive state is configured to indicate that the device has not yet performed the action. The first node is also configured to provide the indication to the second node configured to operate in the communications system. The second node is configured to manage, via the first application programming interface, the third node configured to operate in the communications system. The third node is configured to manage the captivity portal accessible by the device to perform the action. The indication is configured to indicate the state of the device has been set to captive state for the action.

According to a sixth aspect of embodiments herein, the object is achieved by the second node, for handling performance of the action by the device. The second node is configured to operate in the communications system. The device is configured to operate in the communications system via the connection through the data session. The second node is further configured to obtain the indication from the first core network node configured to operate in the communications system. The second node is configured to manage, via the first application programming interface, the third node configured to operate in the communications system. The third node is configured to manage the captivity portal accessible by the device to perform the action. The indication is configured to indicate the state of the device has been set to captive state for the action. The captive state is configured to indicate that the device has not yet performed the action. The second node is also configured to provide, based on the indication configured to be obtained, the additional indication to or towards the device. The additional indication is configured to indicate to the device to contact the third node to perform the action via the captivity portal.

According to a seventh aspect of embodiments herein, the object is achieved by the third node, for handling performance of the action by the device. The third node is configured to operate in the communications system. The device is configured to operate in the communications system via the connection through the data session. The third node is further configured to obtain the further indication from the first core network node configured to operate in the communications system, the further indication. The further indication is configured to indicate the action to be performed by the device via the captivity portal configured to be managed by the third node and accessible by the device to perform the action. The further indication is configured to be provided via the second service-based interface. The third node is also configured to facilitate, based on the further indication configured to be obtained, performance of the action by the device via the captivity portal.

According to an eighth aspect of embodiments herein, the object is achieved by the communications system, for handling performance of the action by the device. The communications system comprises the first node, the second node and the third node. The communications system is further configured to set, by the first core network node, based on the determination that the device is to perform an action with the communications system, the captivity state of the device to the captive state. The captive state is configured to indicate that the device has not yet performed the action. The communications system is also configured to provide, by the first core network node, the indication to the second node. The second node is configured to manage, via the first application programming interface, the third node. The third node is configured to operate in the communications system. The third node is configured to manage the captivity portal accessible by the device to perform the action. The indication is configured to indicate the state of the device has been set to captive state for the action. The communications system is further configured to obtain, by the second node, the indication from the first core network node. The communications system is additionally configured to provide, by the second node, based on the indication configured to be obtained, the additional indication to or towards the device. The additional indication is configured to indicate to the device to contact the third node to perform the action via the captivity portal. The communications system is also configured to obtain, by the third node, the further indication from the first core network node. The further indication is configured to indicate the action to be performed by the device via the captivity portal configured to be managed by the third node and accessible by the device to perform the action. The further indication is configured to be provided via the second service-based interface. The second node is also configured to facilitate, by the third node, based on the further indication configured to be obtained, performance of the action by the device via the captivity portal.

As a first advantage, embodiments herein may be understood to allow a network operator to support user notification in a simple an effective way: the device 130, e.g., the OS of the device 130 may prompt the user and the notification cannot be missed.

As another advantage, embodiments herein may be understood to be based on IETF CAPPORT, which may be understood to solves a well-known problem of the interaction with CAPTIVE portals, which has motivated early adoption in UE OS. Android and iOS have some support and promote their implementation so as their future enhancement plans. Embodiments herein may be understood to involve only mobile network updates, which may simplify implementation and adoption.

As a further advantage, embodiments herein may be understood to not piggyback on the user traffic, as opposed to e.g., redirect. Therefore, embodiments herein may be understood to not be affected by traffic evolution, e.g., traffic encryption or new transport protocols. Embodiments herein may work when the user traffic may be encrypted, e.g., HTTPS/TLS, or with QUIC based applications. Embodiments herein may not be limited to certain applications, as opposed to e.g., redirect working only when using HTTP based applications.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a 5G Network Architecture.

FIG. 2 is a schematic diagram illustrating a non-limiting example of a Captive Portal, according to existing methods.

FIG. 3 is a schematic diagram illustrating a non-limiting example of a communications system, according to embodiments herein.

FIG. 4 is a flowchart depicting embodiments of a method in a first core network node, according to embodiments herein.

FIG. 5 is a flowchart depicting embodiments of a method in a second node, according to embodiments herein.

FIG. 6 is a flowchart depicting embodiments of a method in a third node, according to embodiments herein.

FIG. 7 is a flowchart depicting embodiments of a method in a communications system, according to embodiments herein.

FIG. 8 is a schematic diagram illustrating a non-limiting example of a communications system comprising a captive portal, according to embodiments herein.

FIG. 9 is a schematic diagram depicting a non-limiting example of signalling between nodes in a communications system, according to embodiments herein.

FIG. 10 is a schematic diagram depicting a non-limiting example of signalling between nodes in a communications system, according to embodiments herein.

FIG. 11 is a schematic diagram depicting a non-limiting example of signalling between nodes in a communications system, according to embodiments herein.

FIG. 12 is a schematic diagram depicting a non-limiting example of signalling between nodes in a communications system, according to embodiments herein.

FIG. 13 is a schematic diagram depicting a non-limiting example of signalling between nodes in a communications system, according to embodiments herein.

FIG. 14 is a schematic diagram depicting a non-limiting example of signalling between nodes in a communications system, according to embodiments herein.

FIG. 15 is a schematic diagram depicting a non-limiting example of signalling between nodes in a communications system, according to embodiments herein.

FIG. 16 is a schematic diagram depicting a non-limiting example of signalling between nodes in a communications system, according to embodiments herein.

FIG. 17 is a schematic diagram depicting a non-limiting example of signalling between nodes in a communications system, according to embodiments herein.

FIG. 18 is a schematic diagram depicting a non-limiting example of signalling between nodes in a communications system, according to embodiments herein.

FIG. 19 is a schematic diagram depicting a non-limiting example of signalling between nodes in a communications system, according to embodiments herein.

FIG. 20 is a schematic diagram depicting a non-limiting example of signalling between nodes in a communications system, according to embodiments herein.

FIG. 21 is a schematic block diagram illustrating two non-limiting examples, a) and b), of a first core network node, according to embodiments herein.

FIG. 22 is a schematic block diagram illustrating two non-limiting examples, a) and b), of a second node, according to embodiments herein.

FIG. 23 is a schematic block diagram illustrating two non-limiting examples, a) and b), of a third node, according to embodiments herein.

FIG. 24 is a schematic block diagram illustrating two non-limiting examples, a) and b), of a communications system, according to embodiments herein.

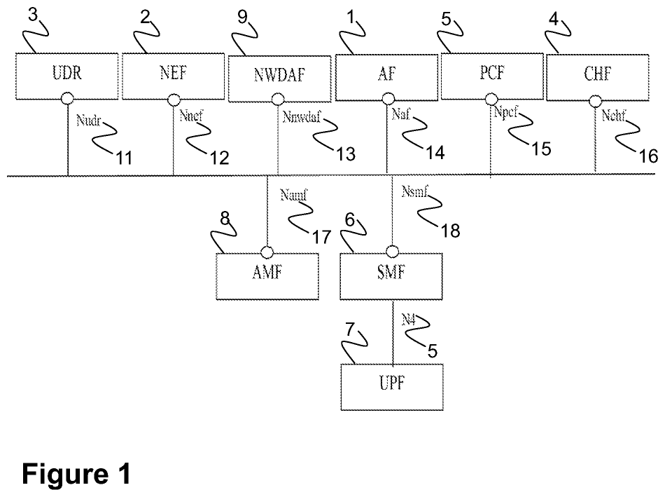

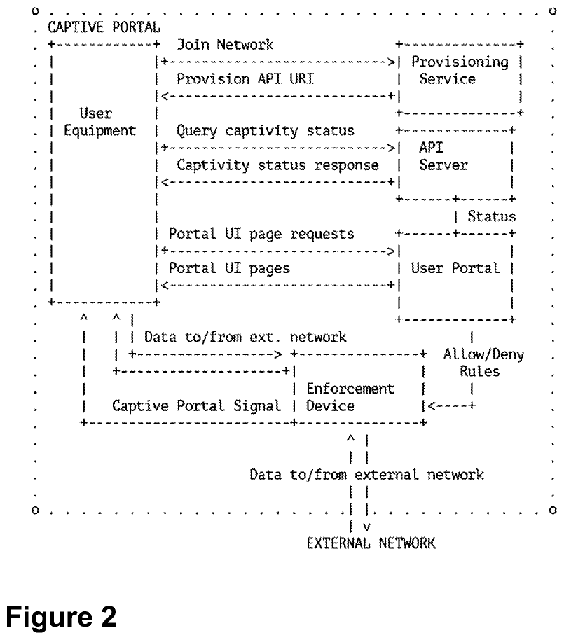

### DETAILED DESCRIPTION

Embodiments herein may be understood to relate to a mechanism which may be understood to solve the problems with the existing methods described in the Summary section. The mechanism may be based on reusing and/or extending the IETF CAPPORT framework for the use cases relative to user notification in a communication system, such as e.g., in a 5G network.

As a summarized overview, embodiments herein may be understood to comprise a mechanism based on reusing and/or extending the IETF CAPPORT framework for exposure between a Mobile Network Operator (MNO) and a UE Operative System in the context of a communication system, e.g., a 5G networks. The disclosed mechanism may allow the MNO to support user notification, even when the traffic may be encrypted, such as with HTTPS/TLS, QUIC and/or DNS encryption, and traditional techniques, e.g., redirect, for notifying the user cannot be used.

Embodiments herein may comprise a specific type of AF, the 5GC API Server, which may behave towards a UE as an API Server, as in the IETF CAPPORT Request for Comments (RFCs), and as an AF towards the rest of 5GC NFs. The AF according to embodiments herein may support a Service Based Interface (SBI) towards the 5GC NFs to expose the API Server service, which may allow to update a user Captivity state in relation to an action that may be required by a user.

Embodiments herein may also comprise a specific type of AF, the 5GC CAPPORT portal, which may be understood to behave towards the UE as a user portal, as in the IETF CAPPORT RFCs, and as an AF towards the 5GC NFs. This AF may support an SBI that may be used to provision the specific user actions that the user may need to be prompted to perform.

Also according to embodiments herein, 5GC NFs may be understood to be consumers of the API Server service and interact with the API Server to set a captivity state when a certain user action may be required, and to clear the captivity state when the action may be performed.

Embodiments herein may further enable to interact with rest of 5GC NFs to control the enforcement of any limitations in the user access due to the pending user action, such as e.g., limited data access or throughput.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

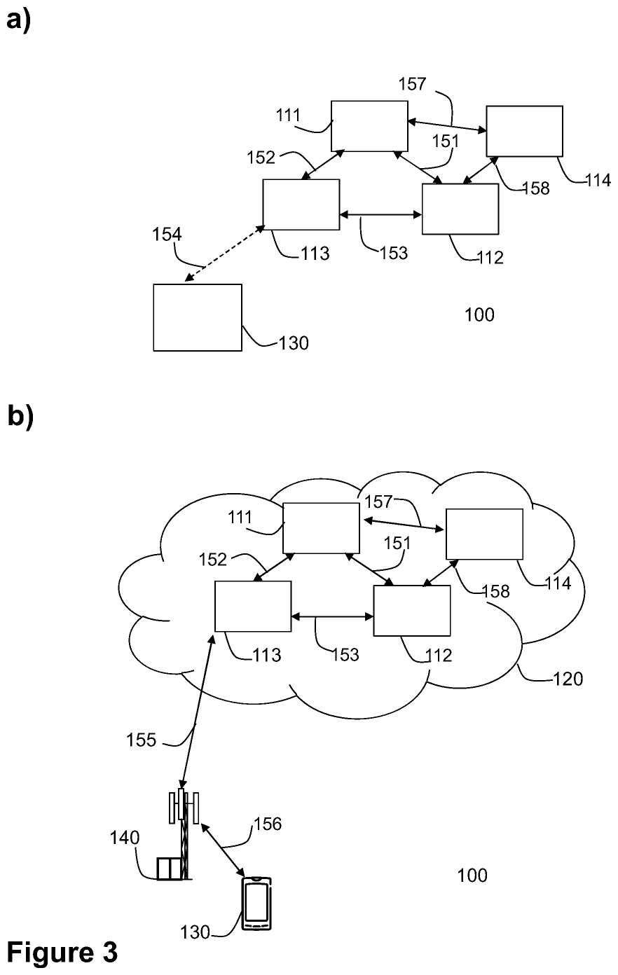

FIG. 3 depicts two non-limiting examples, in panels “a” and “b”, respectively, of a communications system 100, in which embodiments herein may be implemented. In some example implementations, such as that depicted in the non-limiting example of FIG. 3a, the communications system 100 may be a computer network. In other example implementations, such as that depicted in the non-limiting example of FIG. 3b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or a newer system supporting similar functionality. The telecommunications system may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first core network node 111, a second node 112, a third node 113 and another core network node 114 are depicted in FIG. 3. Any of the first core network node 111, the second node 112, the third node 113 and the another core network node 114 may be understood, respectively, as a first computer system, a second computer system, a third computer system and a fourth computer system. In some examples, any of the first core network node 111, the second node 112, the third node 113 and the another core network node 114 may be implemented as a standalone server in e.g., a host computer in the cloud 120, as depicted in the non-limiting example depicted in panel b) of FIG. 3. Any of the first core network node 111, the second node 112, the third node 113 and the another core network node 114 may in some examples be a distributed node or distributed server, with some of their respective functions being implemented locally, e.g., by a client manager, and some of its functions implemented in the cloud 120, by e.g., a server manager. Yet in other examples, any of the first core network node 111, the second node 112, the third node 113 and the another core network node 114 may also be implemented as processing resources in a server farm.

In some embodiments, any of the first core network node 111, the second node 112, the third node 113 and the another core network node 114 may be independent and separated nodes. In other embodiments, any of the first core network node 111, the second node 112, and the third node 113 may be co-located or be the same node. In some embodiments, at least two of the first core network node 111, the second node 112 and the third node 113 may be one of: co-localized and the same node. All the possible combinations are not depicted in FIG. 3 to simplify the Figure.

It may be understood that the communications system 100 may comprise more nodes than those represented on panel a) of FIG. 3.

In some examples of embodiments herein, the first core network node 111 may be understood as a node, such as a NF, e.g., a 5GC NF, which may be a consumer of a service, e.g., an API Service, provided by the second node 112, e.g., an API Server, and interact with the second node 112, when an action may need to be performed by a device 130. In some examples, the first core network node 111 may be managed by a different party than the second node 112 and the third node 113. Non-limiting examples of the first core network node 111 may be a CHF, a PCF, and/or a Unified Data Management (UDM). In some examples, the first core network node 111 may be a core network node acting on behalf of a consumer of any of the services provided by the second node 112 and/or the third node 113. In some of such examples, the first core network node 111 may be an SMF.

The second node 112 may be a node having a capability to manage an API server. The second node 112 may be also understood to have a capability to be a consumer of the third node 113. In particular examples, the second node 112 may be a specific type of AF, a 5GC API Server, which may behave towards a device 130, e.g., a UE, as an API Server, as in the IETF CAPPORT Request for Comments (RFCs), and may behave towards the rest of core network nodes, e.g., 5GC NFs, as an AF. The AF according to embodiments herein may support a Service Based Interface (SBI) towards the 5GC NFs to expose the API Server service, which may allow to update a user Captivity state in relation to an action that may be required by a user. In particular examples, the second node 112 may be an AF, e.g., in a 5G network, managing a CAPPORT API Server, and may be a consumer of a CAPPORT User Portal service.

The third node 113 may be a node having a capability to manage a captivity portal. In some particular examples, the third node 113 may be an AF, e.g., in a 5G network, managing a CAPPORT user portal. In particular examples, the third node 113 may be a specific type of AF, e.g., the 5GC CAPPORT portal, which may be understood to behave towards a device 130, e.g., a UE, as a user portal, as in the IETF CAPPORT RFCs, and may behave towards the rest of core network nodes, e.g., 5GC NFs, as an AF. This AF may support an SBI that may be used to provision the specific user actions that the user may need to be prompted to perform. The third node 113 may support an SBI towards the 5GC NFs to expose a captivity portal service, e.g., a CAPPORT user Portal service.

The another core network node 114 may be, for example, an NRF.

The communications system 100 may comprise a plurality of devices whereof a device 130 is depicted in FIG. 3. The device 130 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a radio network node 140 is depicted in FIG. 3b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first core network node 111 may communicate with the second node 112 over a first link 151, e.g., a radio link or a wired link. The first core network node 111 may communicate with the third node 113 over a second link 152, e.g., a radio link or a wired link. The third node 113 may communicate, directly or indirectly, with the second node 112 over a third link 153, e.g., a radio link or a wired link. The third node 113 may communicate, directly or indirectly, with the device 130 over a fourth link 154, e.g., a radio link or a wired link. The third node 113 may communicate, directly or indirectly with the radio network node 140 over a fifth link 155, e.g., a radio link or a wired link. The radio network node 140 may communicate with the device 130 over a sixth link 156, e.g., a radio link. The first core network node 111 may communicate with the fourth node 114 over a seventh link 157, e.g., a radio link or a wired link. The fourth node 114 may communicate, directly or indirectly, with the second node 112 over an eighth link 158, e.g., a radio link or a wired link. Any of the first link 151, the second link 152, the third link 153, the fourth link 154, the fifth link 155, the sixth link 156, the seventh link 157 and/or the eighth link 158 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 3.

In general, the usage of “first”, “second”, “third”, “fourth”, “fifth”, “sixth”, “seventh” and/or “eighth” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies. For example, although the examples of embodiments herein may be described in the context of a 5G network architecture, the same mechanisms may be applied to a 4G network, just by replacing: CHF by Online Charging System (OCS), PCF by Policy and Charging Rules Function (PCRF), SMF by Packet Data Network (PDN) Gateway Control Function (PGW-C) or Traffic Detection Function Control plane Function (TDF-C), UPF by PDN Gateway User Plane Function (PGW-U) or Traffic Detection Function User plane Function (TDF-U), NEF by Service Capability Exposure Functions (SCEF), UDR by Subscription Profile Repository (SPR) and UDM by Home Subscriber Server (HSS).

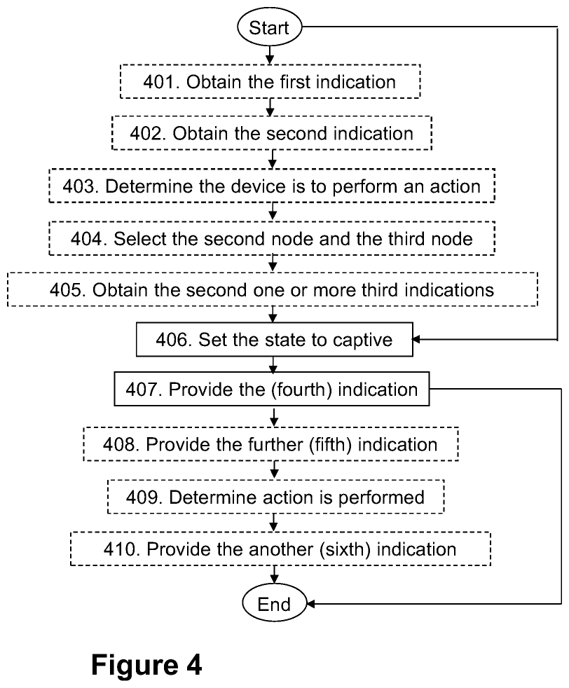

Embodiments of a computer-implemented method, performed by the first core network node 111, will now be described with reference to the flowchart depicted in FIG. 4. The method may be understood to be for handling performance of an action by the device 130. The first core network node 111 operates in the communications system 100. The device 130 operates in the communications system 100 via a connection through a data session. The method may comprise the actions described below. In some embodiments all the actions may be performed. In some embodiments some of the actions may be performed. In FIG. 4, optional actions are indicated with a dashed box. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

In FIG. 4, optional actions are represented with dashed boxes.

### Action 401

In this Action 401, the first core network node 111 may obtain a first indication that the second node 112 may provide a first service enabling to notify the device 130 to perform an action via a captivity portal managed by the third node 113. The second node 112 manages, via a first application programming interface, the third node 113 operating in the communications system 100. The third node 113 manages the captivity portal accessible by the device 130 to perform the action.

The action may be understood as a provision of input by a user of the device 130, which may affect the ability of the device 130 to operate in the communications system 100. An example of such an operation may be the provision of authentication or credentials by user of the device 130. Another example of such an operation may be acceptance of subscription conditions by the user. Yet another example of such an operation may be if a user of the device 130 is offered to opt in for network actions that may improve transmission efficiency when entering certain e.g., busy, areas, such as for example, video quality downgrade. This may be understood to enable the communications system 100 manage its resources in an improved manner, and thereby improve its performance. A further example of such an operation may be, after a user of the device 130 may have run out of quota, refilling the account of the subscriber. The action may be a User Action in CAPPORT.

The first service may be understood to enable that a consumer of the first service, such as the first core network node 111, may modify a captivity state, e.g., CAPPORT Captivity State, for a Protocol Data Unit (PDU) session for the user of the device 130. That is, the first service may enable the first core network node 111 to set the captivity state to “captive”. The first service consumers may also be enabled to indicate the event, e.g., the action that may be required to be performed by the user, that may trigger the “captive” state, and additional information if needed. This first service may also enable that the first service consumers clear the captivity state, e.g., when the action may have been performed. In some non-limiting examples, the first service may enable the first core network node 111 to place the device 130 in a state wherein the device 130 may be prevented from proceeding with its usual operation in the communications system 100 until the user may have performed the action that may be required.

The third node 113, may have a capability to prompt a user of the device 130 to perform the action in order to leave the “captive” state on a User PDU Session. The captivity portal managed by the third node 113 may be understood as an API that may enable to present information to a user of the device 130, such as which action the user may need to perform, and which may enable to receive input from the user of the device 130, so that the user may perform the action. The captivity portal may be a CAPPORT User Portal.

The obtaining of the first indication may be performed by receiving the first indication from another core network node 114 such as, e.g., an NRF in examples wherein the communications system may be a 5G network. In such examples, the first indication may be a response to a request from the first core network node 111, e.g., an Nnrf_NFDiscovery Request. The request from the first core network node 111 may have indicated that the first core network node 111 may have wished to discover a type of node, e.g., a type of NF, being an AF, e.g., “NFType=AF”, and for a type of service, e.g., NF service, being an APIServer, e.g., as “NFService=Naf_APIServer”. The first core network node 111 may then obtain the first indication as a response to that request. The first indication may comprise the instance address of the second node 112, e.g., as an API Server Instance Address. This non-limiting example is illustrated in FIG. 13.

In other examples, the first core network node 111 may obtain the first indication by retrieving it from a memory storage. This may be performed, for example, if the first indication may have been previously received, or if the first indication may have been pre-configured in the first core network node 111.

By obtaining the first indication in this Action 401, the first core network node 111 may be enabled to be aware that the second node 112 may be available to provide the first service enabling to notify the device 130 to perform the action via the captivity portal managed by the third node 113, and thereby to be aware that the first core network node 111 may instruct the second node 112 accordingly when such a notification may be required.

### Action 402

In this Action 402, the first core network node 111 may obtain a second indication that the third node 113 may provide a second service enabling to notify the device 130 to perform the action via the captivity portal managed by the third node 113. The third node 113, may have a capability to prompt the user of the device 130 to perform the action on a PDU session for the user.

The second service may enable that a consumer of the second service, such as the first core network node 111, may provision the specific action or actions that the captivity portal may need to prompt the user to perform to leave the “captive” state, so the device 130 may then be able to resume its operations in the communications system 100. The second service may be a CAPPORT user Portal service.

Similarly to Action 401, the obtaining of the second indication may be performed by receiving the second indication from another core network node such as, e.g., an NRF in examples wherein the communications system may be a 5G network, such as the NRF described in Action 401. In such examples, the second indication may be another response to another request from the first core network node 111, e.g., an Nnrf_NFDiscovery Request. The another request from the first core network node 111 may have indicated that the first core network node 111 may have wished to discover another type of node, e.g., NF, being an AF, e.g., “NFType=AF”, and for another type of service, e.g., NF service, being a User Portal, e.g., as “NFService=Naf_UserPortal”. The first core network node 111 may then obtain the second indication as another response comprising the instance address of the third node 113, e.g., as a User Portal Instance Address. This non-limiting example is illustrated in FIG. 15.

In other examples, the first core network node 111 may obtain the second indication by retrieving it from a memory storage. This may be performed, for example, if the second indication may have been previously received, or if the second indication may have been pre-configured in the first core network node 111.

By obtaining the second indication in this Action 402, the first core network node 111 may be enabled to be aware that the third node 113 may be available to provide the second service enabling to notify the device 130 to perform the action via the captivity portal managed by the third node 113, and thereby instruct the third node 113 accordingly when such a notification may be required, either directly, or via the second node 112.

### Action 403

During the course of communications in the communications system 100, the first core network node 111 may determine, in this Action 403, that the device 130 may need to perform the action. This may correspond to an occurrence of an event, such as, e.g., after a user of the device 130 may have entered a busy area and the user may qualify to be offered an opt in to resolution network downgrade. As another non-liming example of an event, the user of the device 130 may have run out of quota and may need to refill his or her account. How the determining in this Action 403 may be performed, may be understood to depend on the nature of the action, which may vary from use case to use case.

### Action 404

In this Action 404, the first core network node 111 may select at least one of the second node 112 and the third node 113, based on at least one of the obtained first indication, and the second indication. The first core network node 111 may select at least one of the second node 112 and the third node 113 for later providing, in Action 407, an indication to the second node 112 operating in the communications system 100. The indication may indicate that the state of the device 130 has been set to a captive state for the action.

The captive state may be understood as a state wherein the operations or connection of the device 130 in the communications system 100 may be modified, e.g., suspended, restricted or altered, until the device 130 performs the action.

The selecting of the second node 112, e.g., an API Server, may be performed when there may be several nodes having an equivalent capability to that of the second node 112 in the communications system 100. For example, when there may be several API Servers in a 5GC Network. In such examples, it may be understood that Action 401 may have been performed for each of the existing second nodes 112.

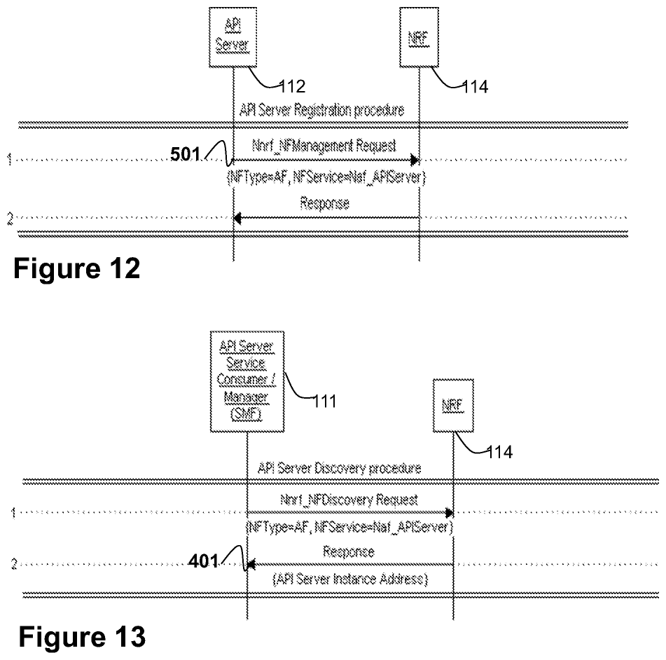

In some examples, there may be different second nodes 112 for different use cases. If so, the first core network node 111 may need to need to consider which type the second node 112 may be, both when the second node 112 may register as a provider of the first service, and in any discovery request for the second node 112, which will be respectively described in FIG. 12 and FIG. 13.

The selection of the second node 112, e.g., an API Server with a Captivity State of a User PDU Session, may be performed using a local configuration or using another core network node, e.g., a Network Repository Function (NRF).

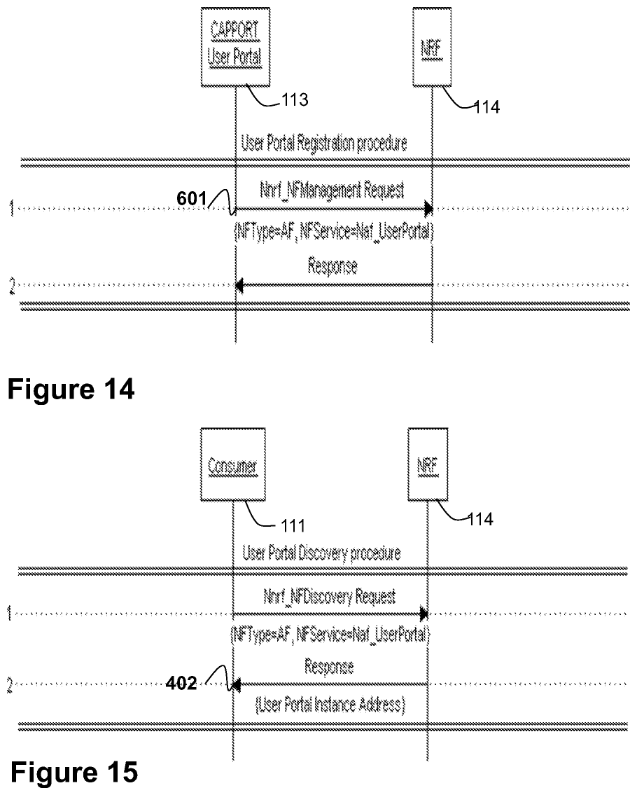

Similarly, the selecting of the third node 113, which may manage e.g., the CAPPORT User Portal, may be performed when there may be several nodes having an equivalent capability to that of the third node 113 in the communications system 100. For example, when there may be several CAPPORT user Portals in a 5GC Network. The third node 113 may be selected using a local configuration or using an NRF. There may be different third nodes 113 for the different use cases. If so, the NRF procedures may need to consider a type of the third node 113, both in a registration of the third node 113, e.g., the CAPPORT User Portal registration, in e.g., the NRF, and in the request leading to the obtaining of the second indication in Action 402, e.g., in the CAPPORT User Portal discovery request. Further detail about these procedures is depicted with non-limiting examples in FIG. 14 and FIG. 15.

By selecting at least one of the second node 112 and the third node 113 in this Action 404, the first core network node 111 may be enabled to choose the second node 112 and the third node 113 that may be specialized for the needs that the notification to the device 130 and the action to be performed by the device 130 may have.

In alternative examples, a different core network node, e.g., an SMF, on behalf of the first core network node 111, may select the second node 112 for the PDU Session, and request a resource for the second node 112, for the captivity state for the User PDU Session.

### Action 405

In in this Action 405, the first core network node 111 may obtain one or more third indications identifying at least one of: the second node 112, and the captivity portal via which the device 130 may need to perform the action.

The one or more third indications may comprise one or more identifiers of the SBI of resource that may have been created for the second node 112, and/or the third node 113. The resource may be, for example, a resource identifier, and/or an address, such as e.g., an API Server address and Resource Id, for the second node 112, and a CAPPORT User Portal address and Resource Id, for the third node 113.

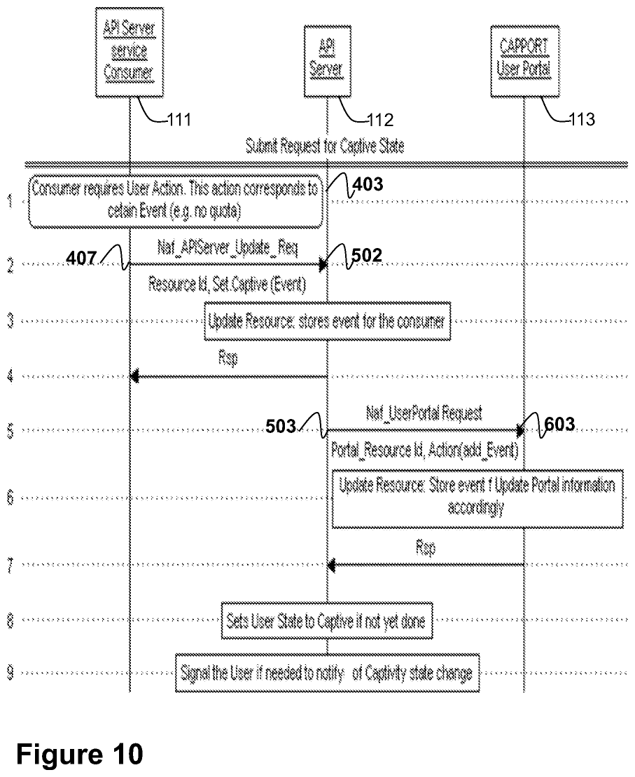

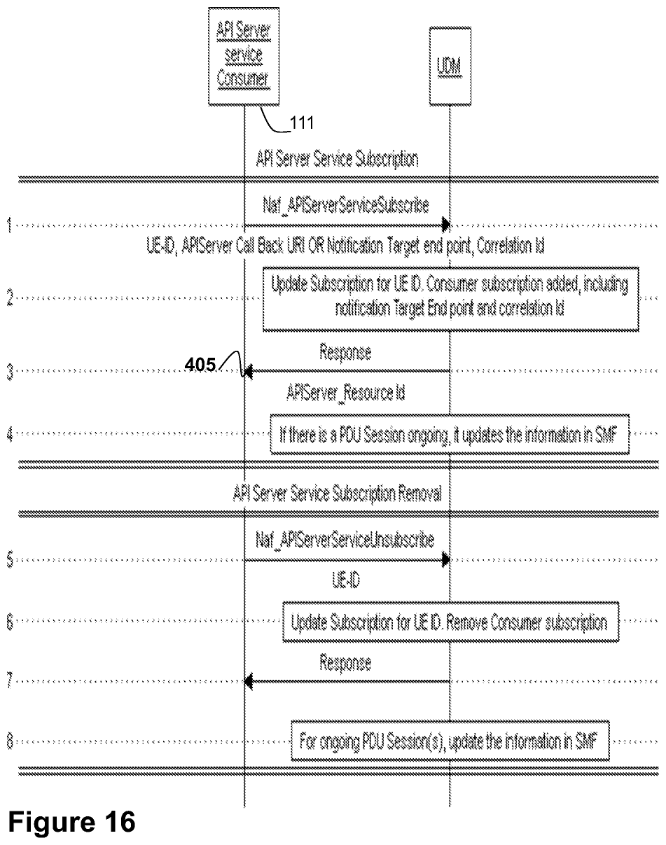

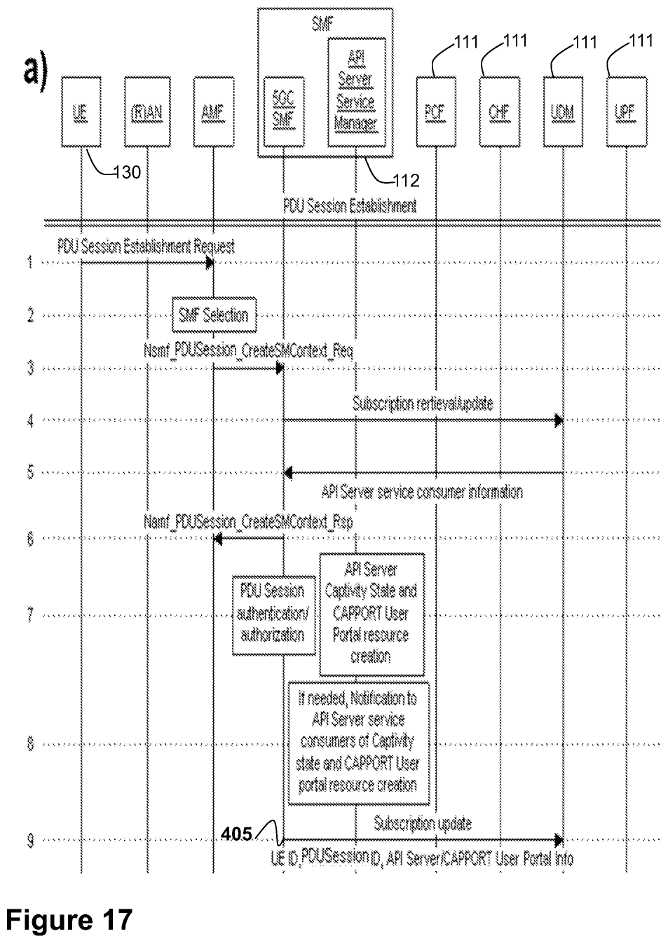

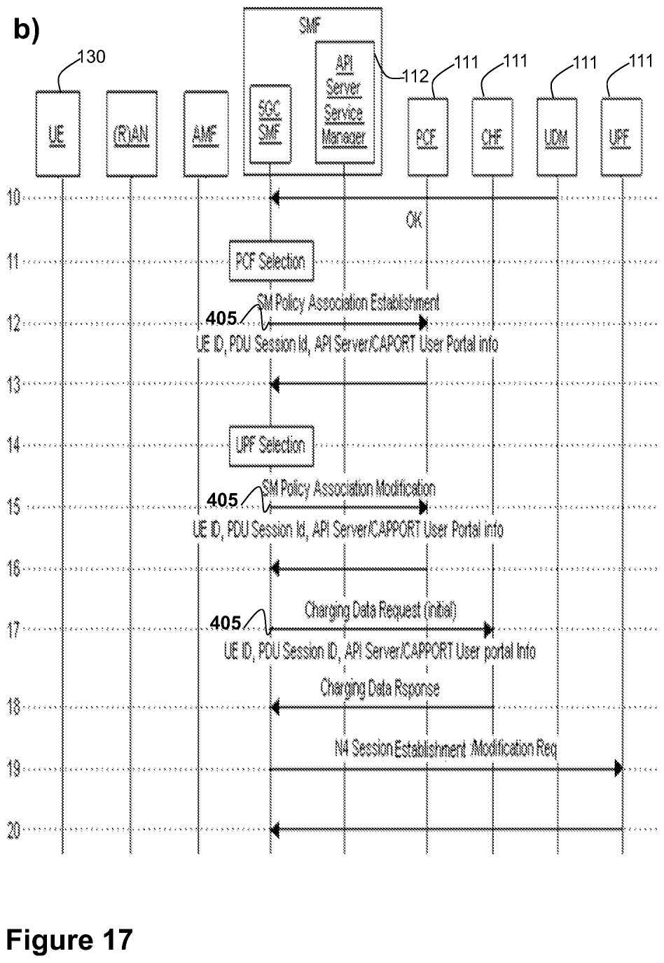

In a particular non-limiting example, the first core network node 111 may, in this Action 405, obtain SBI identifiers of API Server resource that may have been created, such as address and Resource Id of an API Server, and address and Resource Id of a CAPPORT User Portal resource. The first core network node 111 may need the resource that may have been created to update a captivity state for a User PD Session, e.g., as in FIG. 10. The SMF may have provided the SBI identifiers of the created API Server resource. This may have been performed, in some examples, with a notification to the first core network node 111 according to the notification address and correlation Id provided in the subscription, see FIG. 16. In other examples, the SMF may have provided the SBI identifiers of the created API Server resource to e.g., the UDM, the PCF and the CHF extending with this information the SMF-UDM Subscription Update service, the SMF-PCF SM Policy Association service and the SMF-CHF Charging Data Service, see FIG. 17.

The captivity state, e.g., the API Server Captivity State, for the User PDU Session may be identified, e.g., with a URI on the UE access, and with the API Server address plus a Resource Id, unique within the CAPPORT User Portal, by the API Server service consumers such as the first core network node 111.

The captivity portal, e.g., a CAPPORT User Portal for the User PDU Session captivity state, may be identified with a URI on the UE access, and with the CAPPORT User Portal address plus a Resource Id, unique within the API Server, by the CAPPORT user portal service consumers such as the first core network node 111.

In another particular non-limiting example, the first core network node 111 may, in this Action 405, obtain an API Server Call Back URI for the User PDU Session that the SMF may have provisioned to the device 130 using Non-Access Stratum, e.g., extended Protocol Configuration Options (PCO), Routing Advertisement (RA) or Dynamic Host Configuration Protocol (DHCP).

The first core network node 111 may obtain the one or more third indications from a different core network node, e.g., the UDM according to a “Static” alternative or the SMF in some examples according to a “Dynamic” alternative. The SMF may have been provisioned with information of the API Server service consumers such as the first core network node 111, on whose behalf it may perform as an API Server Service manager. The SMF may have obtained this information, see FIG. 17 from the UDM as part of the subscription data for the session. For this purpose, the subscription data may be extended with this information and the API Server service consumers may need to subscribe to this service, see FIG. 16. The SMF may have obtained this information from the individual consumers, e.g., the PCF and CHF. The SMF-PCF SM Policy Association service may be extended with this information, so as the SMF-CHF Charging Data Service. The SMF may provision the device 130 with the URI of the second node 112, e.g., an API Server URI for the PDU Session, using the CAPPORT UE provisioning mechanisms. According to a “Static” alternative, the SMF may provision the device 130 with the API Server URI for the UE access received in the subscription data. According to a “Dynamic” alternative, the SMF may provision the device 130 with the API Server URI for the UE access that the API Server may provide in the response to the request for a captivity state resource for the User PDU Session.

In some embodiments, the action may be one of a plurality of actions to be performed by the device 130. Each of the actions may be to be performed by the device 130 via a respective captivity portal. In some of such embodiments, each respective captivity portal may be identifiable by respective one or more third indications.

In some examples, the first core network node 111 may obtain the one or more third indications by receiving a notification according to a notification address and correlation Id that may have been provided in a subscription, as e.g., described in the non-limiting example of FIG. 16. In such examples, the first core network node 111 may have subscribed to the first service, e.g., an API Server Service, in order to e.g., receive events related to creation of an API Server Resource for a PDU Session. The first core network node 111 may subsequently unsubscribe when those events may no longer be of interest.

In particular examples, in order to enable the performance of this Action 405, the CAPPORT UE provisioning mechanisms, as e.g., defined in the CAPPORT RFCs may be extended to include also the extended PCO that 3GPP NAS signaling may provide at PDU Session Establishment or Modification. The extended PCO may be extended to include the URI(s) for the second node 112, e.g., the API Server URI(s) for the User PDU Session.

All CAPPORT UE provisioning mechanisms, e.g., RA, DHCP and/or extended PCO, may be extended to allow to provision multiple API Server URIs to the device 130 for the User PDU Session. Different second nodes 112, e.g., API Servers, may provide captivity states and portals that may correspond to different use cases e.g., user account, user consent, etc.

The first core network node 111, e.g., a 5GC NF that may be an API Server service consumer, may have requested resource for the second node 112 to handle a captivity state for a PDU Session for the device 130, if needed, as will be described in further detail in FIG. 16. The second node 112 may have provided a URI that may identify the resource on the access for the device 130 and that it may need to be made known to the SMF.

In some examples, the first core network node 111 may obtain its own one or more third indications, making them available in the UDM, so they may be made known to the SMF. The SMF may then provision them to the device 130.

By obtaining the one or more third indications in this Action 405, the first core network node 111 may be enabled to be aware that the third node 113 may be available and may be prepared to provide the second service enabling to notify the device 130 to perform the action via the captivity portal managed by the third node 113. The first node 111 may thereby be enabled to instruct the third node 113 accordingly when such a notification may be required, either directly, or via the second node 112.

By obtaining the one or more third indications in this Action 405, the first core network node 111 may be further enabled to provision the device 130 with the API Server Call Back URI(s).

### Action 406

In this Action 406, the first core network node 111, sets, based on a determination in Action 403 that the device 130 is to perform the action with the communications system 100, the captivity state of the device 130 to a captive state. The captive state indicates that the device 130 has not yet performed the action. The first core network node 111 may set the captivity state of the device 130 to the captive state directly, or it may perform this Action 406 indirectly, by instructing another node, e.g., the second node or another core network node to do it.

In some embodiments wherein the device 130 may need to perform a plurality of actions, the setting in this Action 406 of the captivity state may comprise consolidating the plurality of actions into a single captivity state.

In embodiments herein, wherein the communications system may be a 5G network, at least the following 5GC NFs may be consumers of the second node 112, e.g., API Server service consumers. In a first example, the first core network node 111 may be a CHF, which for example may set the User PDU Session captivity state to “captive with action required “quota refill” when a user may run out of quota. While this action may be pending, the user data access on the session may be restricted. For example, the user may be able to communicate only with the API Server and the CAPPORT user portal over this PDU session. In a second example, the first core network node 111 may be a PCF, which for example may set the User PDU Session captivity state to “captive” with action required “consent needed” when certain policies may require explicit consent, e.g., special policies at roaming. While this action is not performed, the user data access on the session may be restricted. For example, the throughput may be downgraded or the user may be able to communicate only with the second node 112 and the third node 113, e.g., over the CAPPORT user portal, over this PDU session. In a third example, the first core network node 111 may be a UDM, which for example may set the User PDU Session captivity state to “captive” with action required “consent needed” when the exposure of certain subscriber information may require so. While this action is not performed, the exposure of the user may be restricted. For example, the user location may be not provided, affecting the Quality of Experience (QoE) of a given service. In a fourth example, the first core network node 111 may be an SMF, which for example may set the User PDU Session captivity state to “captive” and apply restrictions on the PDU session on behalf of other NFs.

In some embodiments wherein the communications system 100 may be a 5G network, at least the following 5GC NFs may be CAPPORT User Portal service consumers. In a first example, the first core network node 111 may be an API Server, which may be in charge of keeping the captivity state and the CAPPORT User portal aligned at all times. In a second example, the first core network node 111 may be a CHF, PCF, UDM and SMF, when API Server service consumers may update both the API Server Captivity State for the PDU Session, and the CAPPORT User portal, and keep them aligned.

By setting the captivity state of the device 130 to the captive state, the first core network node 111 may enable to support user notification in a simple an effective way, by having the Operating System (OS) of the device 130 prompt the user to perform the action or actions, so that the notification cannot be missed. Since common OSs, such as Android and iOS, may provide support and promote implementation of the captivity state, implementation of embodiments herein may be understood to advantageously only involve mobile network updates, which may be understood to simplify implementation and adoption.

Furthermore, embodiments herein may be understood to not piggyback on the user traffic, in contrast to, e.g., redirect approaches. Therefore, traffic evolution e.g., traffic encryption or new transport protocols, may be understood to not affect the implementation of embodiments herein. Embodiments herein may be understood to advantageously work when the user traffic may be encrypted, e.g., HTTPS/TLS, or with QUIC based applications. Embodiments herein may also not be limited to certain applications, as opposed to e.g., redirection approaches, which may be understood to only work when using HTTP based applications.

### Action 407

Whenever the first core network node 111 may, as a result of Action 403, require that a certain action, that is, a user action, is performed by the device 130, e.g., the CHF may require a user account refill, the first core network node 111 may become an API Server service consumer and use, e.g., the API Server SBI to interact with the second node 112, and optionally, it may also be a CAPPORT user portal service consumer.

In this Action 407, the first core network node 111, provides an indication, that is, another indication which may be referred to herein as a fourth indication, to the second node 112 operating in the communications system 100. As stated earlier, the second node 112 manages, via the first API, the third node 113 operating in the communications system 100. Also as stated earlier, the third node 113 manages the captivity portal accessible by the device 130 to perform the action. The indication indicates the state of the device 130 has been set to captive state for the action.

In some embodiments, the providing of the indication, that is, the fourth indication, may be performed via a first service-based interface (SBI).

In some embodiments wherein the first core network node 111 may manage the data session, e.g., the PDU session, the first core network node 111 may, in this Action 407, provide the obtained one or more third indications to the device 130. The fourth indication may comprise at least one of the obtained one or more third indications in Action 404.

The sending of the fourth indication may be performed e.g., via the first link 151.

In addition, and depending on regulation, user contract and/or operator policies, the first core network node 111 may use existing mechanisms, e.g., policy and charging control or exposure access control, to make sure the corresponding restrictions may be applied as long as the user action is not performed. The limitations may be enforced, e.g., limited internet access, or restricted Quality of Service (QoS), as long as the “captive” state remains.

By sending the fourth indication in this Action 407, the first core network node 111 may enable to support user notification in a simple an effective way, by having the Operating System (OS) of the device 130 prompt the user so that the notification cannot be missed. Since common OSs, such as Android and iOS, may provide support and promote implementation of the captivity state, implementation of embodiments herein may be understood to advantageously only involve mobile network updates, which may be understood to simplify implementation and adoption.

Furthermore, embodiments herein may be understood to not piggyback on the user traffic, in contrast to, e.g., redirect approaches. Therefore, traffic evolution e.g., traffic encryption or new transport protocols, may be understood to not affect the implementation of embodiments herein. Embodiments herein may be understood to advantageously work when the user traffic may be encrypted, e.g., HTTPS/TLS, or with QUIC based applications. Embodiments herein may also not be limited to certain applications, as opposed to e.g., redirection approaches, which may be understood to only work when using HTTP based applications.

Embodiments herein may further enable to interact with rest of 5GC NFs to control the enforcement of any limitations in the user access due to the pending user action, such as e.g., limited data access or throughput.

### Action 408

In this Action 408, the first core network node 111 may provide a further indication, which may be understood to be a fifth indication, indicating the action determined to have to be performed by the device 130 via the captivity portal. The further indication may be provided to one of: a) the second node 112, via the first SBI, and b) the third node 113, via a second SBI.

The first core network node 111 may, in this Action 408, include, in the further indication, the event that may have triggered the “captive” state to provide information of the required action. The second node 112 may then use this information to provision itself the captivity portal, e.g., the CAPPORT User Portal, so that the portal may prompt the user to perform the right actions to leave the “captive” state.

By providing the further indication in this Action 408, the first core network node 111 may enable that either the second node 112 instructs the third node 113, or that the first core network node 111 directly instructs the third node 113, to facilitate that the device 130 is presented with an interface, the captivity portal, wherein the device 130 may be enabled to perform the action, thereby enabling that the notification to the device 130 to perform the action reaches the device 130 and is not missed.

### Action 409

In this Action 408, the first core network node 111 may determine that the device 130 has performed the action via at least one of the captivity portal and another interface with the communications system 100.

By determining that the device 130 has performed the action in this Action 409, the first core network node 111 may then be enabled to instruct to clear the captive state and allow the device 130 to resume its operations in the communications system 100.

### Action 410

In this Action 410, the first core network node 111 may provide, after determining 409 that the device 130 has performed the action, another indication, which may be understood to be a sixth indication, to the second node 112. The another indication may indicate to the second node 112 to clear the captive state. This Action 410 may be understood to be performed after the first core network node 111 may have determined that the action has been performed in Action 409.

In some examples, first core network node 111 may provide the another indication to the third node 113.

In particular examples, the first core network node 111 may request to update the captivity state for the data session, e.g., the User PDU Session. The first core network node 111 may set the captivity state to “captive” when certain action may be required, and it may clear it when the action may already have been performed. Further details are provided in the example depicted in FIG. 10, “API Server service consumer updates Captivity state”.

By providing the another indication in this Action 410, the first core network node 111 may therefore enable the device 130 to continue with its operations in the communications system 100, after the action may have been performed.

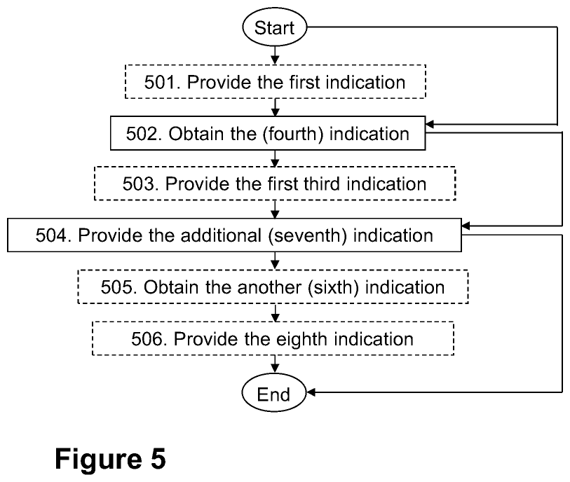

Embodiments of a computer-implemented method performed by the second node 112, will now be described with reference to the flowchart depicted in FIG. 5. The method may be understood to be for handling performance of the action by the device 130. The second node 112 operates in the communications system 100. The device 130 operates in the communications system 100 via the connection through the data session.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 5, optional actions are depicted with dashed lines.

The detailed description of some of the following corresponds to the same references provided above, in relation to the actions described for the first core network node 111 and will thus not be repeated here to simplify the description. For example, the first core network node 111 may manage the data session.

### Action 501

In this Action 501, the second node 112 may provide, to the another core network node 114, the first indication that the second node 112 may provide the first service enabling to notify the device 130 to perform the action via the captivity portal managed by the third node 113.

As mentioned earlier, the another core network node 114 may be, e.g., the NRF.

The providing, e.g., sending, of the first indication may be performed e.g., via the first link 151.

At least two of the first core network node 111, the second node 112 and the third node 113 may be one of: co-localized and the same node.

### Action 502

In this Action 502, the second node 112 obtains the indication from the first core network node 111 operating in the communications system 100. The indication obtained from the first core network node 111 may be understood to be the fourth indication. The second node 112 manages, via the first API, the third node 113 operating in the communications system 100. The third node 113 manages the captivity portal accessible by the device 130 to perform the action. The fourth indication indicates the state of the device 130 has been set to captive state for the action. The captive state indicates that the device 130 has not yet performed the action.

The obtaining, e.g., receiving, of the fourth indication may be performed e.g., via the first link 151. The obtaining of the fourth indication may be performed via the first SBI.

The obtaining of the fourth indication in this Action 502 may be understood to be based on the provided first indication. That is, the second node 112 may obtain the fourth indication after having provided the first indication to the first core network node 111 that the second node 112 may provide the first service, or may have the resources to provide the first service.

The obtaining of the fourth indication in this Action 502 may be based on the second indication and the third indication, which may be needed to set the captivity state.

The second node 112 may also obtain, e.g., in this Action 502 or in another Action, the further indication from the first core network node 111, which may be understood to be the fifth indication, indicating the action determined to have to be performed by the device 130 via the captivity portal.

### Action 503

As stated earlier, the indication obtained from the first core network node 111 in Action 502 may be understood to be the fourth indication. In some embodiments, the fourth indication may comprise at least one of one or more third indications identifying at least one of: the second node 112, and the captivity portal via which the device 130 is to perform the action. In some of these embodiments, in this Action 503, the second node 112 may provide, to the third node 113, a first third indication of the one or more third indications identifying the captivity portal via which the device 130 may be required to perform the action.

The providing, e.g., sending, of the fourth indication may be performed e.g., via the third link 153.

In some embodiments, the action may be one of the plurality of actions to be performed by the device 130, wherein each of the actions may need to be performed by the device 130 via the respective captivity portal. In some of such embodiments, each respective captivity portal may be identifiable by respective one or more third indications.

In some embodiments, the plurality of actions may be consolidated into a single captivity state. The second node 112, e.g., an API Server, may consolidate in a single Captivity State multiple requests from multiple API server service consumers for the same data session, e.g., User PDU Session, if needed, e.g., to comply with current CAPPORT RFCs. This may be done in order to provide the device 130 with a single consolidated captivity state for the User PDU Session and related captivity information, e.g., the URL of the CAPPORT user portal, independently of the Use case.

In another particular non-limiting example, the second node 112 may obtain a CAPPORT User Portal Call Back URI for the User PDU Session captive state that it may provide to the device 130 upon captivity state request when captive.

### Action 504

In this Action 504, the second node 112 provides, based on the obtained fourth indication, an additional indication to or towards the device 130. The additional indication indicates to the device 130 to contact the third node 113 to perform the action via the captivity portal. The additional indication may be understood to be a seventh indication.

The providing, e.g., sending, of the fourth indication may be performed directly, via a respective link, or via the third node 113, e.g., via the third link 153 and the fourth link 154.

The providing of the seventh indication may be understood to be based on the obtained fourth indication, since it may be understood that the second node 112 may provide the seventh indication with the proviso that it may have obtained the fourth indication.

The providing of the seventh indication may be based on the obtained fifth indication.

### Action 505

In this Action 505, the second node 112 may obtain another indication from the first core network node 111. The another indication may indicate to the second node 112 to clear the captive state. The another indication may be understood to be the sixth indication.

The obtaining, e.g., receiving, of the sixth indication may be performed e.g., via the first link 151.

### Action 506

In this Action 506, the second node 112 may provide, to the third node 113 and based on the obtained another indication, an eighth indication. The eighth indication may indicate to remove the action from the captivity portal.

The providing, e.g., sending, of the eighth indication may be performed, e.g., via the third link 153.

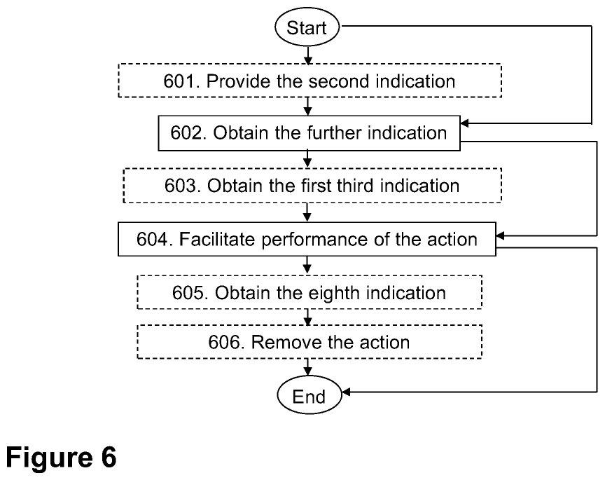

Embodiments of a computer-implemented method performed by the third node 113, will now be described with reference to the flowchart depicted in FIG. 6. The method may be understood to be for handling performance of the action by the device 130. The third node 11e operates in the communications system 100. The device 130 operates in the communications system 100 via the connection through the data session.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 6, optional actions are depicted with dashed lines.

The detailed description of some of the following corresponds to the same references provided above, in relation to the actions described for the first core network node 111 and will thus not be repeated here to simplify the description. For example, the first core network node 111 may manage the data session.

### Action 601

In this Action 601, the third node 113 may provide, to the another core network node 114, e.g., the NRF, the second indication that the third node 113 may provide the second service enabling to notify the device 130 to perform the action via the captivity portal managed by the third node 113.

The providing, e.g., sending, of the second indication may be performed e.g., via a respective link not depicted in FIG. 3.

At least two of the first core network node 111, the second node 112 and the third node 113 may be one of: co-localized and the same node.

### Action 602

In this Action 602, the third node 113 obtains the further indication from the first core network node 111 operating in the communications system 100. The further indication indicates the action to be performed by the device 130 via the captivity portal managed by the third node 113 and accessible by the device 130 to perform the action. The further indication is provided via a second SBI. The third node 113 may obtain the further indication from the first core network node 111 directly, or it may perform this Action 602 by obtaining the further indication indirectly, via another node, e.g., the second node.

### Action 603

In this Action 603, the third node 113 may obtain, from the second node 112, a first third indication identifying the captivity portal via which the device 130 may have to perform the action.

The first third indication may be, for example, a Naf_UserPortal Update Req, comprising a Portal_Resource ID, and the action to be performed by the user.

Action 603 may be performed in a different order than that depicted in FIG. 6. For example, Action 603 may be performed before Action 602.

### Action 604

In this Action 604, the third node 113 facilitates, based on the obtained further indication, performance of the action by the device 130 via the captivity portal. In other words, the third node 113 may, in this Action 604, provide the captivity portal with the action. Depending on implementation, provision of the captivity portal, e.g., the CAPPORT User Portal, with the action in this Action 604, e.g., User Action information, may comprise that the captivity portal may prompt the user to perform the right actions to leave the “captive” state.

To comply with current CAPPORT RFCs, the third node 113, e.g., managing one CAPPORT user portal, may consolidate the requests from multiple CAPPORT User Portal consumers in order to the present the user a single portal for actions related to Captivity state for the user PDU Session. The CAPPORT User portal may redirect the user to specific portals for certain requests, e.g., a refill portal.

### Action 605

In this Action 605, the third node 113 may obtain, from the second node 112 operating in the communications system 100, the second node 112 managing the third node 113 via the first API, the eighth indication. The eighth indication may indicate to remove the action from the captivity portal. This may be understood to be based on the determination that the user may have performed the action.

### Action 606

In this Action 606, the third node 113 may remove the action from the captivity portal, based on the obtained eighth indication.

In some examples, the third node 113 may receive the another indication from the first core network node 111. The another indication may indicate to the second node 112 to clear the captive state.

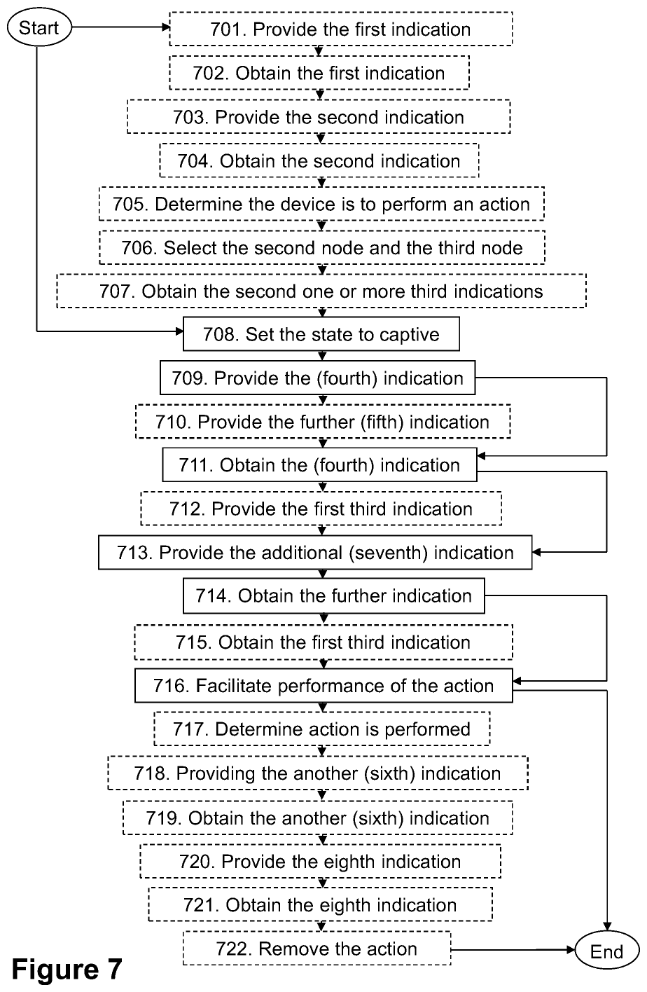

Embodiments of a computer-implemented method, performed by the communications system 100, will now be described with reference to the flowchart depicted in FIG. 7. The method may be understood to be for handling performance of the action by the device 130. The communications system 100 comprises the first core network node 111, the second node 112 and the third node 113. The device 130 operates in the communications system 100 via the connection through the data session.

In some embodiments, at least two of the first core network node 111, the second node 112 and the third node 113 may be one of: co-localized and the same node.

The method may comprise the actions described below. In some embodiments some of the actions may be performed. In some embodiments all the actions may be performed. In FIG. 7, optional actions are indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first core network node 111 and will thus not be repeated here to simplify the description. For example, the first core network node 111 may manage the data session.

### Action 701

This Action 701, which corresponds to Action 501, may comprise, providing 701, by the second node 112, to the another core network node 114, the first indication that the second node 112 may provide the first service enabling to notify the device 130 to perform the action via the captivity portal managed by the third node 113. The obtaining in Action 711 of the fourth indication may be based on the provided first indication.

### Action 702

In some embodiments, the method may comprise, in this Action 702, which corresponds to Action 401, comprises, obtaining 702, by the first core network node 111, the first indication that the second node 112 may provide the first service enabling to notify the device 130 to perform the action via the captivity portal managed by the third node 113.

### Action 703

In this Action 703, which corresponds to Action 601, the method may comprise, providing 703, by the third node 113, to the another core network node 114, the second indication that the third node 113 may provide the second service enabling to notify the device 130 to perform the action via the captivity portal managed by the third node 113.

### Action 704

This Action 704, which corresponds to Action 402, may comprise, obtaining 704, by the first core network node 111, the second indication.

### Action 705

In some embodiments, the method may comprise, in this Action 403, which corresponds to Action 302, determining, by the first core network node 111, that the device 130 may have to perform the action.

### Action 706

In some embodiments, the method may comprise, in this Action 404, which corresponds to Action 303, selecting 706, by the first core network node 111, at least one of the second node 112 and the third node 113 for the providing in Action 709 of the fourth indication, based on at least one of the obtained first indication, and the second indication.

### Action 707

This Action 707, which corresponds to Action 405, may comprise obtaining, by the first core network node 111, the one or more third indications identifying at least one of: the second node 112, and the captivity portal via which the device 130 may have to perform the action. The fourth indication may comprise at least one of the obtained one or more third indications.

In some embodiments, the action may be one of the plurality of actions to be performed by the device 130, wherein each of the actions may have to be performed by the device 130 via the respective captivity portal. Each respective captivity portal may be identifiable by the respective one or more third indications.

The first core network node 111 may manage the data session, and the first core network node 111 may provide the obtained one or more third indications to the device 130.

### Action 708

This Action 708, which corresponds to Action 406, comprises setting, by the first core network node 111, based on the determination that the device 130 is to perform the action with the communications system 100, the captivity state of the device 130 to the captive state. The captive state indicates that the device 130 has not yet performed the action.

In some embodiments, the setting in this Action 708 of the captivity state may comprise consolidating the plurality of actions into a single captivity state.

### Action 709

This Action 709, which corresponds to Action 407, comprises, providing, by the first core network node 111, the indication to the second node 112. The second node 112 manages, via the first API, the third node 113 operating in the communications system 100. The third node 113 manages the captivity portal accessible by the device 130 to perform the action. The indication indicates the state of the device 130 has been set to captive state for the action.

In some embodiments, the providing of the indication may be performed via the first SBI.

The indication may be understood to be the fourth indication.

### Action 710

This Action 710, which corresponds to Action 408, may comprise providing, by the first core network node 111, the further indication indicating the action determined to have to be performed by the device 130 via the captivity portal. The further indication may be provided to one of: a) the second node 112, via the first SBI, and c) the third node 113, via the second SBI.

### Action 711

This Action 711, which corresponds to Action 502, comprises, obtaining, by the second node 112, the indication from the first core network node 111. The captive state indicates that the device 130 has not yet performed the action.

The indication obtained from the first core network node 111 may be the fourth indication.

The fourth indication may comprise at least one of one or more third indications identifying at least one of: the second node 112, and the captivity portal via which the device 130 may have to perform the action.

The obtaining of the indication by the second node 112 may be performed via the first SBI.

### Action 712

This Action 712, which corresponds to Action 503, may comprise providing, by the second node 112, to the third node 113, the first third indication of the one or more third indications identifying the captivity portal via which the device 130 may have to perform the action.

### Action 713

In some embodiments, the method comprises, in this Action 713, which corresponds to Action 504, providing, by the second node 112, based on the obtained indication, the additional indication to or towards the device 130. The additional indication indicates to the device 130 to contact the third node 113 to perform the action via the captivity portal.

### Action 714

In some embodiments, the method comprises, in this Action 714, which corresponds to Action 602, obtaining, by the third node 113, the further indication from the first core network node 111. The further indication indicates the action to be performed by the device 130 via the captivity portal managed by the third node 113 and accessible by the device 130 to perform the action. The further indication is provided via the SBI.

### Action 715

This Action 715, which corresponds to Action 503, may comprise obtaining, by the third node 113, from the second node 112, the first third indication.

### Action 716

This Action 716, which corresponds to Action 604, comprises, facilitating 716, by the third node 113, based on the obtained further indication, performance of the action by the device 130 via the captivity portal.

### Action 717

This Action 717, which corresponds to Action 409, may comprise determining, by the first core network node 111, that the device 130 has performed the action via at least one of the captivity portal and another interface with the communications system 100.

### Action 718

In some embodiments, the method may comprise, in this Action 718, which corresponds to Action 410, providing, by the first core network node 111, after determining in Action 717 that the device 130 has performed the action, another indication to the second node 112. The another indication indicates to the second node 112 to clear the captive state. The additional indication may be understood to be the seventh indication.

### Action 719

In some embodiments, the method may comprise, in this Action 719, which corresponds to Action 505, obtaining, by the second node 112, another indication from the first core network node 111. The another indication may indicate to the second node 112 to clear the captive state.

### Action 720

This Action 720, which corresponds to Action 506, may comprise providing, by the second node 112, to the third node 113 and based on the obtained another indication, the eighth indication indicating to remove the action from the captivity portal.

### Action 721

In some embodiments, the method may comprise, in this Action 721, which corresponds to Action 605, obtaining 721, by the third node 113, from the second node 112, the eighth indication.

### Action 722

In some embodiments, the method may comprise, in this Action 722, which corresponds to Action 606, removing, by the third node 113, the action from the captivity portal, based on the obtained eighth indication.

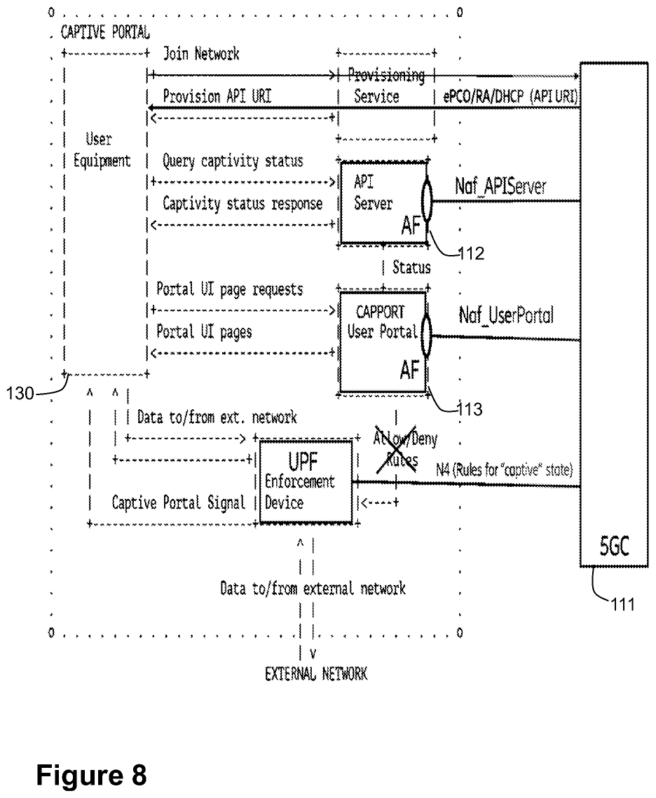

Embodiments herein will now be described with particular non-limiting examples. In the description of FIG. 8-FIG. 20, it may be understood that any detailed description provided in reference to any particular exemplary entity, e.g., any of the PCF, API Server, CAPPORT User Portal, for, respectively, the first core network node 111, the second node 112 and/or the third node 113, may equally apply to the first core network node 111, the second node 112 and/or the third node 113.

FIG. 8 is a schematic diagram depicting a non-limiting example of the architecture of the communications system 100, wherein the communication system 100 is a 5G network. In this non-limiting example, the first core network node 111 is a 5G core network, the second node 112 is an API Server, and the third node 113 manages a CAPPORT User Portal. There may be several possible implementations for the second node 112 and the CAPORT User Portal elements in the 5GC Architecture, such as, the following examples. In a first example, the second node 112 may be the only consumer of the CAPPORT User Portal service. It may update the portal when it may handle the requests to change the captivity state. In a second example, the service consumers of the second node 112 may be also CAPPORT User Portal service consumers: they may update both the CAPPORT User portal and the captivity state of the second node 112, and keep them aligned. In a third example, the CAPPORT User portal and the second node 112 may be integrated. The implementation may follow the first example, but the second node 112 and the third node 113 may communicate using an internal interface. In a fourth example, the second node 112, the CAPPORT User Portal and the first core network node 111 may be integrated. The implementation may follow the first example or the second example, but the second node 112 and the third node 113 may communicate using internal interfaces. This simplest implementation may be applied e.g., in single use case scenario. In FIG. 8, the first SBI is a Naf_APIServer and the second SBI is a Naf_UserPortal. The first core network node 111 may interact with a UPF, or another enforcement device, to control the enforcement of any limitations in the user access due to the pending user action, such as e.g., limited data access or throughput. This interaction may be performed via an N4 interface, for provide rules for the “captive” state. The first core network node 111, or another core network node operating in the communications system 100, may also provision the one or more third indications, e.g., the API URI, extended PCO, RA, and/or the DHCP to the device 130. The remaining elements in FIG. 8 not described may be performed as in existing methods.

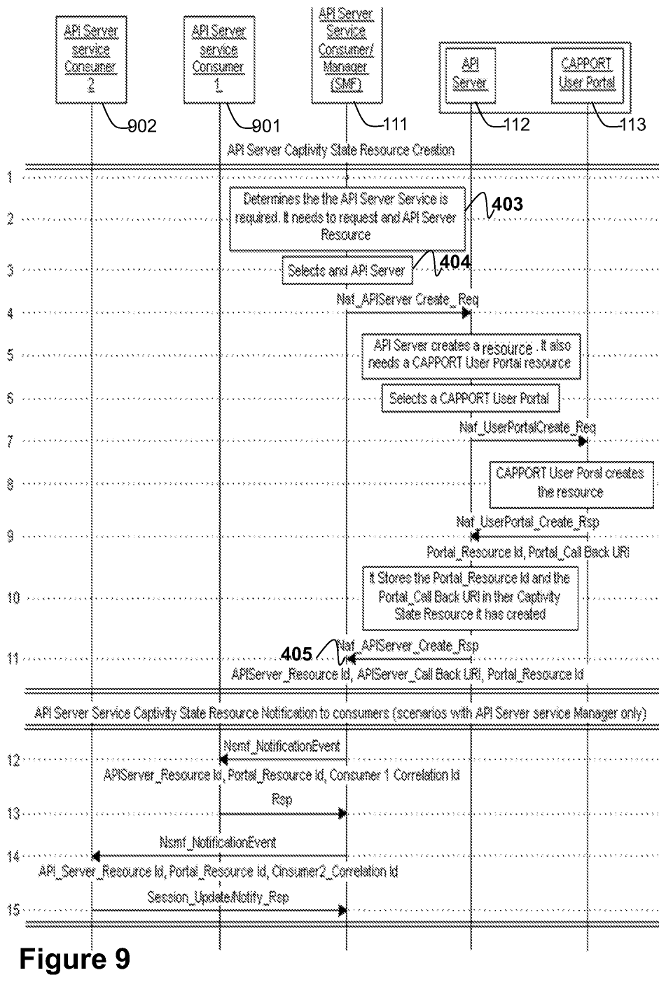

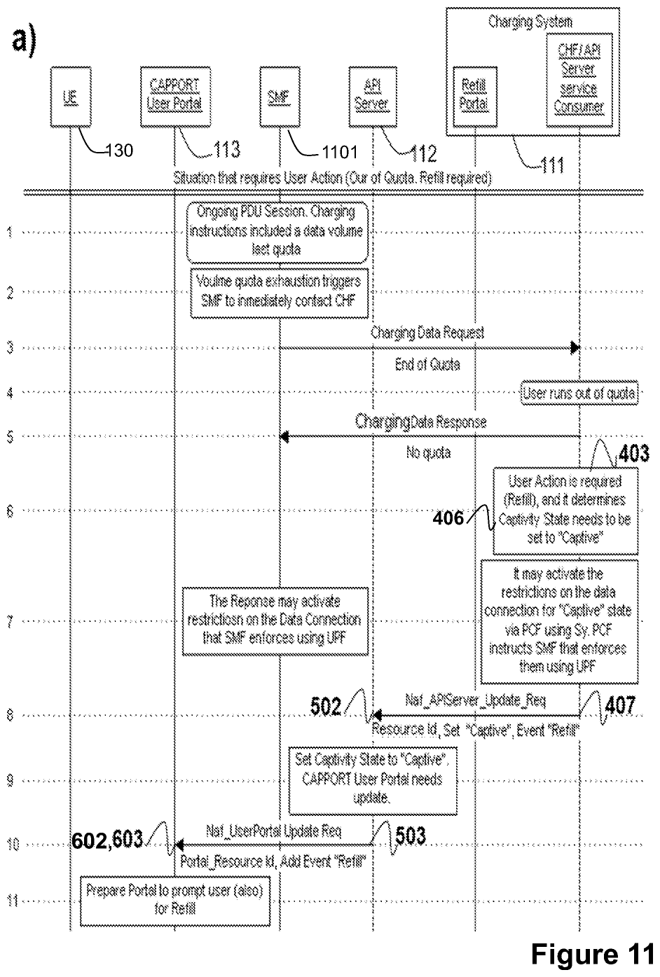

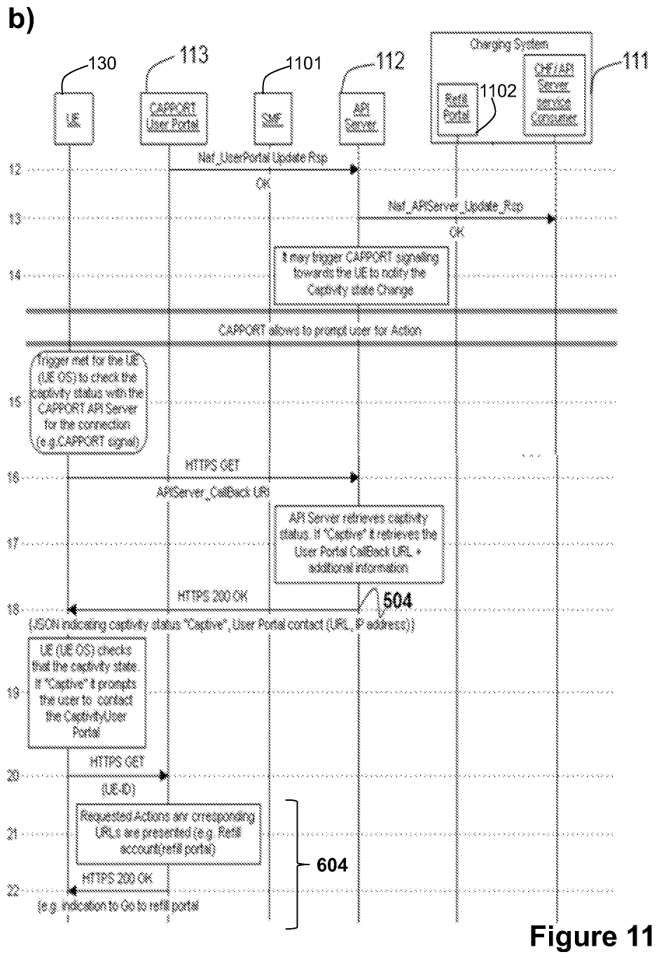

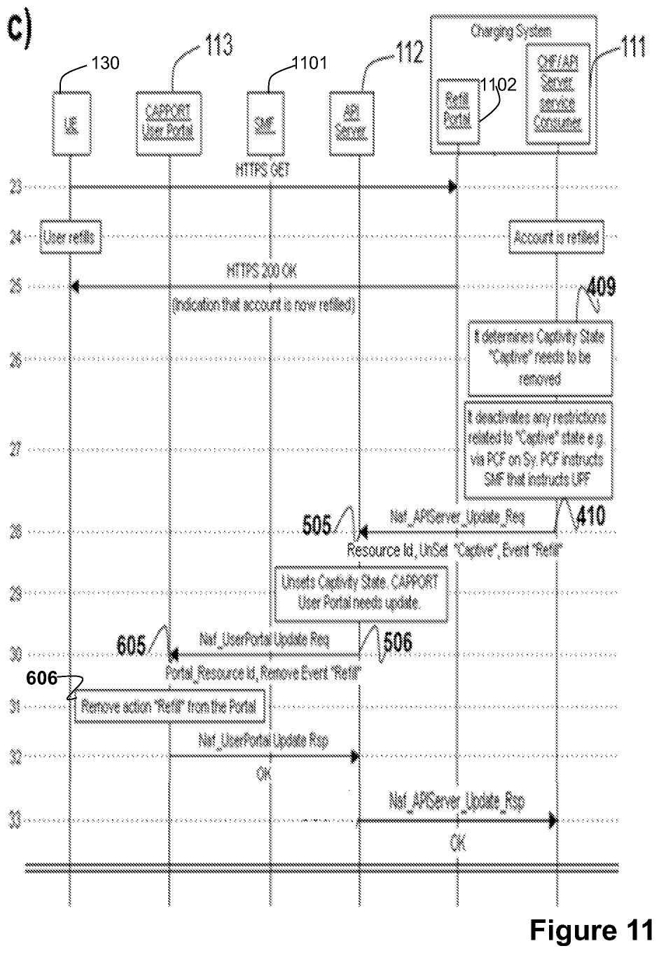

FIG. 9 is a signalling diagram depicting a non-limiting example of API Server Captivity State and CAPPORT User Portal resource Creation, according to embodiments herein. FIG. 9 shows a sequence diagram describing an implementation of the first SBI, in this example, an Naf_APIServer API, and the second SBI, a Naf_UserPortal API, in relation to the creation of the resources that may be required to perform embodiments described herein. In step 2, the first core network node 111, according to Action 403, may determine that the API Server Service may be required and that it may need to request an API Server Resource. In step 3, the first core network node 111, according to Action 404, may select an API server. In step 4, the first core network node 111, may send a Naf_APIServer Create_Req to the second node 112. In step 5, the second node 112 may create a resource. It may also need a CAPPORT user portal resource. In step 6, the second node 112 may selected a CAPPORT User Portal. In step 7, the second node 112 may send a Naf_UserPortalCreat_Req to the third node 113. In step 8, the third node 113, creates the resource. In step 9, the second node 112 may receive a Naf_UserPortal_Create_Rsp comprising the Portal_Resource Id, and the Portal_Call Back URI. In step 10, the second node 112 may store the Portal_Resource ID and the Portal_Call Back URI in the Captivity State Resource it may have created. In step 11, the first core network node 111, may, according to Action 405, obtain the one or more third indications in a Naf_APIServer_Create_Rsp from the second node 112 comprising the APIServer_Resource ID, the APIServer_Call Back URI and the Portal_Resource Id. For API Server Service Captivity State Resource Notification to consumers, in scenarios with API Server service Manager only, in step 12, the first core network node 111 may send an Nsmf_NotificationEvent to another first core network node 901, API Service Consumer 1, comprising at least some of the obtained one or more third indications, such as the APIServer_Resource ID, the Portal_Resource Id, and a Consumer 1 Correlation Id. The Correlation Id may be understood to relate to the subscription as consumer, so the another first core network node 901 may know what this notification may correspond to. In step 13, the first core network node 111 may obtain a response from the another first core network node 901. In step 14, the first core network node 111 may send another Nsmf NotificationEvent to yet another first core network node 902, API Service Consumer 1, comprising at least some of the obtained one or more third indications, such as the APIServer_Resource ID, the Portal_Resource Id, and a Consumer 2 Correlation Id. In step 15, the first core network node 111 may obtain a Session_Update/Notify_Rsp from the yet another first core network node 902. The depicted signalling sequence may be understood to have two parts. The first part may be comprised by steps 1 to 11, which may be triggered by the first core network node 111, the API Server Service Consumer, or by an SMF acting an API Server Service Manager, when the first service, that is, the API Server service may be required. By means of this procedure, first, the API Server Service consumer/manager may receive the one or more third indications, e.g., the API Server Call Back URI for the User PDU Session, which the SMF may provisions to the device 130 using NAS extended PCO, RA or DHCP. Second, the API Server service consumer/manager may receive the API Server Resource Id that it may need to be able to update the captivity state for the User PD Session, e.g., as in FIG. 10. Third, the API Server service consumer/manager may also receive the Portal Resource Id. This may be understood to only be needed if the API Server service consumer may also update the CAPPORT user portal, which may depend on the implementation. And finally, the API Server may receive the Portal Call Back URI that it may need to provide to the device 130 upon captivity state request if captivity state is “captive”. This may be understood to be according to the CAPPORT RFCs, and may allow to request the user to perform any necessary actions. FIG. 11 shows has this is used in an example use case. The second part may be comprised by steps 12 to 15, which may be performed only if the SMF acting as API Server service manager triggers steps 1 to 11, and only if needed. The SMF may send notifications for events related to changes in the user API Server captivity state resources, e.g., creation. By means of this procedure, first, the API Server service consumer may receive the APIServer Resource Id that it may need to be able to update the captivity state in the API Server, including also the IP Sever address. Second, the API Server service consumer may also receive the Portal Resource Id including also the CAPPORT user portal address. This may only be needed if the API Server service consumer also updates the CAPPORT user portal. Third, the notification may include a correlation Id for the API Server Service Consumer to relate the notification event to a former subscription, see FIG. 16. A similar sequence but with Naf_APIServer delete operations may be followed to remove the created resources at PDU Session termination and to notify this event to the consumers if needed. Even if an API Server service manager triggers steps 1 to 11, Steps 12 to 15 may not be needed, for example if the API Server service consumers may be UDM, PCF or CHF. The API Server Resource Id and the Portal Resource Id may be provided using extensions on existing procedures as shown in FIG. 17. Step 3 and Step 11 may be performed based on local configuration or with the assistance of an NRF, see FIGS. 13 and 15.

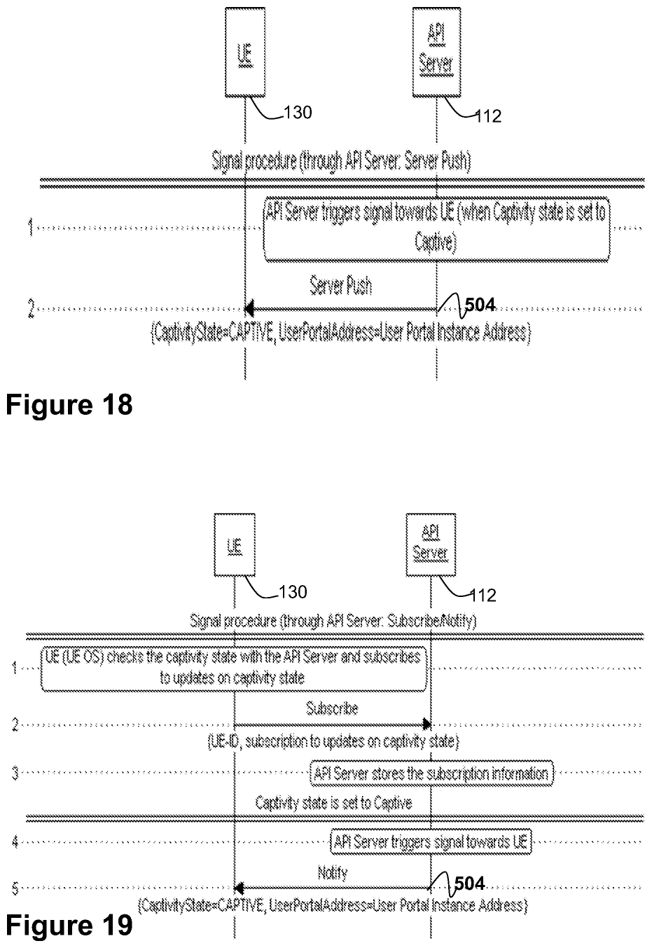

FIG. 10 is a signalling diagram depicting another non-limiting example of an API Server service consumer Captivity State update, according to embodiments herein. FIG. 10 below shows a sequence diagram describing how the first core network node 111, e.g., one of the API Server service consumers, may use a Naf_APIServer API for certain use of the use case. In this procedure, the API Server service consumer may be for example a CHF that may want to prompt a user to do a refill because it may be running out of quota. In another example, it could be a PCF, that may want to prompt the user to give explicit consent to certain policies that may apply when roaming, etc. . . . . In step 1, the API Server service consumer may, according to Action 403, detect the need for a certain user action. This action may correspond to a certain event, e.g., no quota may be left for the user to operate. In step 2, the first core network node 111 may send, according to Action 407, a request to the second node 112, that is, the API Server in charge of the captivity state for this User PDU Session, to set the Capacity State to “captive”. The request, a Naf_APIServer Update_Req, may include at least some of the one or more third indications, e.g., a) the API Server Resource Id, or equivalent, to correlate in the API Server the request with the specific Captivity State that the request may target, that is, the user Captivity State for the User PDU Session. This information may have been received as shown in FIG. 9, b) the requested operation, that is, set captivity state to “captive”, c) the related event that may identify the required user action, e.g., refill, roaming consent . . . and d) any additional information, e.g., those covered in the RFCs for CAPPORT. In steps 3 and 4, the second node 112 may store the information updating the resource and storing the event for the consumer, and answer back. When the consumer itself may needs to update the user portal, the CAPPORT User portal address and the Resource Id, or equivalent, to correlate the portal update request with the portal information for the specific user Captivity State that may have been provided to the consumer, see FIG. 9. The captivity state may be updated at this point. In step 5, the second node 112 may send, according to Action 503, a request to update the portal accordingly. The request may include at least: a) a Portal Resource Id, or equivalent, to correlate the portal update request with the portal information for the specific user Captivity State, and b) the related event that may identify the required user Action, e.g., refill, roaming consent . . . . In steps 6 and 7, the portal may be updated by the third node 113, and the response may be sent back. In step 8, the second node 112 may update the captivity state if not done yet. If the captivity state was already “captive” due to some previous request, it may not change. In step 9, the second node 112 may decide whether to trigger a signal towards the device 130 to notify captivity a state change to trigger the device 130 to contact the captivity state as described in the CAPPORT RFC, see FIGS. 18 and 19. A similar sequence may be followed to clear the captivity state once the user action may have been performed.

FIG. 11 is a signalling diagram depicting a non-limiting example of a use of embodiments herein for an account refill use case using CAPPORT. FIG. 11 shows a sequence diagram describing the proposed implementation for the use case of user account refill based on the described mechanisms. The whole sequence is depicted over three different sections. Section a) is continued in Section b), and Section b) is continued in Section c). In step 1, another core network node 1101, an SMF may determine charging instructions for an ongoing PDU session, including a data volume last quota. In step 2, the another core network node 1101 may determine a volume quota exhaustion which may trigger the another core network node 1101 to immediately contact the first core network node 111, in this example, a CHF. In step 3, the first core network node 111 may receive a charging data request from the another core network node 1101 indicating an end of the quota. In step 4, the first core network node 111 may determine that the user of the device 130 may have run out of quota. In step 5, the first core network node 111 may send a response to the another core network node 1101 indicating that there is no quota. In step 6, the first core network node 111, according to Action 403, may determine that user action may be required, that is, refill, and it may determine that the captivity state of the device 130 may need to be set to “captive”. In step 7, the first core network node 111 may activate the restrictions on the data connection for the “captive” state via the PCF using Sy. The PCF may instruct the SMF, which may enforce them UPF. For the activation of restrictions in step 7, state of the art procedures may be followed. In step 8, the first core network node 111, according to Action 407, sends a Naf_APIServer_Update_Req indicating some of the one or more third indications, particularly, the Resource Id, the state set to “Captive”, and the action, or Event, being “Refill”. The second node mat receive the fourth indication, according to Action 502. In step 9, the second node 112 sets the captivity state to “Captive”, and may determine that the captive portal, that is, the CAPPORT User Portal, may need an update. In step 10, the second node 112, according to Action 503, may send a Naf_USerPortal Update Req to the third node 113, comprising at least some of the one or more third indications, such as Portal_Resource_Id, Add event “Refill”. The third node 113 may receive the first third indication, according to Action 603. In step 11, the third node 113 may prepare the portal to prompt the user to perform the action, that is, the refill. In step 12, the third node 113 may send a Naf_USerPortal Update Rsp to the second node 112 indicating OK. In step 13, the second node 112 may send a Naf_API Server_Update_Rsp to the first core network node 111 indicating OK. In step 14, the second node 112 may trigger CAPPORT signalling towards the device 130 to notify of the captivity state change. CAPPORT may allow to prompt the user of the device 130 for action. In step 15, the device 130 may meet a trigger for the device 130, that is for the OS of the device 130, to check the captivity status with the CAPPORT API Server for the connection, e.g., CAPPORT signal. In step 16, the device 130 may send an HTTPS GET message to the second node 112 indicating the APIServer_CallBack URI. In step 17, the second node 112 may retrieve the captivity status. If “Captive”, the second node 112 may retrieve the User Portal CallBack URL and the additional information. In step 18, the second node 112, according to Action 504, may send the additional indication to the device 130, indicating to contact the third node 113 to perform the action via the captivity portal, with an HTTPS 200 OK, indicating JSON indicating the captivity status has been set to “Captive”, and the User Portal contact, e.g., URL and IP address. In step 19, the device 130, that is the OS of the device 130 may check the captivity state. If “captive”, the device 130 may prompt the user to contact the CaptivityUser Portal. In step 20, the device 130 may send an HTTPS GET to the third node 113 comprising an identifier of the device 130, e.g., UE-ID. In step 21, the third node 113, according to Action 604 may present the device 130 with the requested action and/or actions, and the corresponding URLs, e.g., to refill the account, with the refill portal 1102. In step 22, the third node 113, also according to Action 604, may send back an HTTPS 200 OK with an indication to go to the refill portal. In step 23, the device 130 may send an HTTOS GET to the refill portal 1102. In step 24, the device 130 may perform the action by refilling the account. In step 25, the device 130 may receive an HTTPS 200 OK from the refill portal 1102 indicating that the account is now refilled. In step 26, the first core network node 111, according to Action 409 may determine that the action has been performed and that the captivity state “Captive” may need to be removed. In step 27, the first core network node 111 may deactivate any restrictions related to the “Captive” state, e.g., via the PCF on Sy The PCF may instruct the SMF, which in turn may instruct the UPF. For the deactivation of restrictions in step 27 state of the art procedures may be used. In step 28, the first core network node 111, according to Action 410, may send a Naf_APIServer_Update_Req to the second node 112, comprising the Resource Id, with an indication to UnSet “Captive” for the action, or Event, “Refill”. The second node 112 may receive this in accordance to Action 505. In step 29, the second node 112, may unset the captivity state, and may determine that the CAPPORT User Portal may need an update. In step 30, the second node 112, according to Action 506, may send a Naf_USerPortal Update Req to the third node 113, indicating the Portal_Resource Id, and to remove the Event “Refill”. In step 31, the third node 113 may, according to Action 606, remove the action “Refill” from the Portal. In step 32, the third node 113 may send a Naf_UserPortal Update Resp to the second node 112 indicating OK. In step 33, the second node may send a Naf_USerPortal Update Req to the first core network node 111 indicating OK. For Steps 6 to 14 and Steps 26 to 33 details have been described for the base sequence in FIG. 10. When activation of restrictions may have been triggered by the Charging data Response in step 5, they may also be deactivated at a next Charging Data Req/Rsp when the quota may be provided, that is not shown in the sequence.

FIG. 12 is a signalling diagram depicting a non-limiting example of how the second node 112, an API Server, may register in the another core network node 114, here an NRF, that is FIG. 12 shows an example of NRF assisted API Server Registration. In step 1, the second node 112 may, according to Action 501, send an Nnrf_NFManagement Request to the NRF comprising an indication of the NFTType=AF and the first service as an NFService=Naf_APIServer. In step 2, the second node 112 may receive a response from the NRF.

FIG. 13 is a signalling diagram depicting a non-limiting example of how the second node 112, an API Server, may be discovered by the first core network node 111 assisted by another core network node 114, the NRF, that is FIG. 13 shows an example of NRF assisted API Server Discovery. In step 1, the first core network node 111 may send an Nnrf_NFDiscovery Request to the NRF comprising an indication of the NFTType=AF and the first service as an NFService=Naf_APIServer. In step 2, the first core network node 111 may, according to Action 401, receive a response from the NRF indicating the API Server Instance Address of the second node 112.

FIGS. 12 and 13 may therefore be considered to show sequence diagrams for NRF assisted API Sever selection.

FIG. 14 is a signalling diagram depicting a non-limiting example of how the third node 113, managing a CAPPORT User Portal, may register in the another core network node 114, the NRF, that is FIG. 14 shows an example of NRF assisted CAPPORT User Portal Registration. In step 1, the third node 113 may, according to Action 601, send an Nnrf_NFManagement Request to the NRF comprising an indication of the NFTType=AF and the second service as an NFService=Naf_USerPortal. In step 2, the third node 113 may receive a response from the NRF.

FIG. 15 is a signalling diagram depicting a non-limiting example of how the third node 113, managing a CAPPORT User Portal, may be discovered by the first core network node 111, a consumer of the second service, assisted by the another core network node 114, the NRF, that is FIG. 15 shows an example of NRF assisted CAPPORT User Portal Discovery.

In step 1, the first core network node 111 may send an Nnrf_NFDiscovery Request to the NRF comprising an indication of the NFTType=AF and the second service as an NFService=Naf_UserPortal. In step 2, the first core network node 111 may, according to Action 402, receive a response from the NRF indicating the User Portal Instance Address of the third node 113.

FIGS. 14 and 15 may therefore be considered to show sequence diagrams to allow NRF assisted CAPPORT user portal selection.

FIG. 16 is a signalling diagram depicting a non-limiting example of how the first core network node 111 may subscribe as a consumer of the first service, that is, as an API Server service consumer, according to embodiments herein, and e.g. receive events related to creation of an API Server Resource for the PDU Session, steps 1 to 4, and to unsubscribe when those events may no longer be of interest, steps 5 to 8. The consumer subscription may be performed through a UDM. The goal of the procedure is two-fold: a) to provide to the UDM the API Server Call Back URI that the API Server service consumer may have obtained when creating its own API Server captivity state resource for the user PDU Session as in FIG. 9—the UDM may provide this information to the SMF to provision the device 130, or b) in scenarios where the device 130 may be provisioned with one single API Server URI for the PDU Session and the API Server service consumers may not create their own resource, for the API Server service consumers to receive the identifiers of the API server resource with the captivity state for the PDU Session, e.g., the API Server address and the Resource Id, which may be needed to update the Captivity State for the PDU Session, as in FIG. 10. This may be done, either directly from the UDM, if “static” API server resource creation is used, or in SMF notifications for API server resource events, if “dynamic” API server resource creation by the SMF may be used, see FIG. 9. In step 1, the first core network node 111 may send a Naf_APIServerServiceSubscribe to the UDM, comprising an identifier for the device 130, e.g., a UE-ID, the APIServer Call Back URI OR notification Target end point, and a correlation Id. In step 2, the UDM may update the subscription for the identified device 130. The subscription of the first core network node 111 may be added, including the notification Target Endpoint and the correlation Id. In step 3, the first core network node 111 may receive a response from the UDM with the APIServer_Resource Id. In step 4, the UDM may, if there is a PDU session ongoing, update the information in the SMF. Whenever the API Server Service Subscription Removal may be needed, in step 5, the first core network node 111 may send a Naf_APIServerServiceUnSubscribe to the UDM, comprising an identifier for the device 130, e.g., the UE-ID. In step 6, the UDM may update the subscription for the identified device 130 and remove the subscription of the first core network node 111. In step 7, the first core network node 111 may receive a response from the UDM. In step 8, the UDM, for ongoing PDU session(s), may update the information in the SMF.

In the case of UDM, PCF and CHF, the procedure in FIG. 9, steps 12-15, and FIG. 16, may not be used, and the information needed may be conveyed in operations that may be invoked during PDU Session management procedure. As a result, the sequence in FIG. 16 may not be a prerequisite for those consumers. This case is described in FIG. 17. FIG. 17 is a signalling diagram depicting a non-limiting example of the first steps of a PDU Session Establishment, according to embodiments herein. For this mechanism, the PDU Session Establishment procedure may be enhanced in two ways. If each API Server service consumer requested its own API Server captivity state resource, the SMF would receive from the UDM, in Steps 4 and 5, the API Server Call Back URI(s) of the UDM and other API Server service consumers. The SMF may also receive additional API Server Call Back URI(s) from the PCF in Step 13, and from the CHF in step 18. Then, the SMF may use this information to provision the device 130 using extended PCO/DHCP/RA with the API Server Call Back URI(s) for the PDU Session in the final steps of the PDU Session Establishment procedure, not shown in this sequence. If the API Server captivity state resource for the PDU Session was preconfigured in the system, the SMF may receive from the UDM in Steps 4 and 5, the API Server Call Back URI and optionally, the address of the API Server/CAPPORT User Portal and the corresponding resource that API Server service consumers may need. In this sequence however, the SMF may be acting as the API Server service manager. And so, the SMF may request the API Server Captivity State and CAPPORT User Portal resources in Step 7 on behalf of all the API Server service consumer. In addition, the SMF may provision the device 130 with the API Server Call Back URI that it may have received from the API Server ay API Server Captivity State Resource creation in Step 7. This may happen in the final steps of PDU the Session Establishment procedure, which is not shown in this sequence. The SMF may provide the address of the API Server/CAPPORT User Portal and corresponding resource Ids to the API Server service consumers, who may receive it in agreement with Action 405. To the API Server service consumers that have subscribed to the service with UDM in FIG. 16, using a notification in step 8. For this, the SMF may use the target notification address and correlation Id received from the UDM in steps 4 and 5 in the subscription retrieval operation. To the UDM, extending, the subscription update operation in Step 9. To the PCF and the CHF, adding this information in the SM Policy Association service, in Steps 15 and 16, and the Charging Data Service, in Steps 17 and 18. In step 1, the device 130 may send a PDU Session Establishment Request to the AMF. In step 2, the AMF may select the SMF. In step 3, the AMF may send an Nsmf_PDUSession_CreateSMContext_Req to the SMF, in this example, a 5GC SMF. The SMF may also comprise the second node 112, as an API Server Service Manager. In step 4, the 5GC SMF may send a Subscription retrieval/Update to the UDM. In step 5, the UDM may send back API Server service consumer information. In step 6, the 5GC SMF may send back a Namf_PDUSession_CreateSMContext_Rsp to the AMF. In step 7, the 5GC SMF may perform PDU Session authentication and authorization. The Second node 112 may create resource for the API Server Captivity State and the CAPPORT User Portal. In step 8, the second node 112 may, if needed, send a Notification to the API Server service consumers, such as the first core network node 111, of the Captivity state and the CAPPORT User portal resource creation. In step 9, the 5GC SMF may send a Subscription update to the UDM comprising an identifier for the device 130, e.g., a UE ID, the PDU session ID, the API Server/CAPPORT User Portal Information. In step 10, the 5GC SMF may receive an OK response from the UDM. In step 11, the 5GC SMF may select the PDF. In step 12, the 5GC SMF may send an SM Policy Association Establishment to the PCF, comprising the identifier of the UE, as the UE-ID, the PDU Session ID, and the API Server/CAPPORT User Portal Info, which may be acknowledged by the PCF in step 13. In step 14, the 5GC SMF may select the UPF. In step 15, the 5GC SMF may send an SM Policy Association Modification to the PCF comprising the identifier of the UE, as the UE-ID, the PDU Session ID, and the API Server/CAPPORT User Portal Info, which may be acknowledged by the PCF in step 13 in step 16. In step 17, the 5GC SMF may send a Charging Data Request initial to the CHF comprising the identifier of the UE, as the UE-ID, the PDU Session ID, and the API Server/CAPPORT User Portal Info. In step 18, the 5GC SMF may receive a Charging Data Response from the CHF. In step 19, the 5GC SMF may send an N4 Session Establishment/Modification Request to the UPF. In step 20, the 5GC SMF may receive a response from the UPF.

The SMF may provision the API Server URI(s) for the PDU Session to the device 130 using the CAPPORT UE provisioning mechanisms. This may be done at the PDU Session Establishment and when the API Server URI(s) for the PDU Session may change.

The SMF may obtain the API Server URI(s) for the PDU Session using one or more of the following: a) from the UDM, as part of the subscription data for the session. For this purpose, the subscription data may be extended with this information, b) from the first core network nodes 111, e.g., API Server service consumers such as the PCF and the CHF; The SMF-PCF SM Policy Association service may be extended with this information, so as the SMF-CHF Charging Data Service, and c) from the API Server itself over the new API Server SBI, e.g. in the response to a request to create an API Server resource to handle the Captivity state for the User PDU Session.

The device 130 may need to be provisioned with one single API Server URI for the PDU Session. In this case the device 130 may retrieve one single captivity state for the PDU Session. This may be the case if the UE CAPPORT implementation is as in current CAPPORT RFCs. To address this scenario, the API Server may consolidate in one Captivity state the multiple requests from the API Server service consumers. The following description corresponds to extensions to the mechanism to cope with this scenario. As the simplest “static” alternative for API server resource creation, the API Server resource that may handle the Captivity state for the User PDU Sessions may be preconfigured in the system. The corresponding identifiers, e.g., the URI on the UE access, and API Server address plus Resource Id on the SBI, may be preconfigured and distributed with existing procedures, e.g., as part of subscription data. The same approach may be applied for the CAPPORT User Portal resource. In a more “dynamic” alternative, the SMF may take the role of the API Server Service Manager for the User PDU Session. Depending on the implementation, the SMF may also select the CAPPORT User Portal and request a CAPPORT User Portal resource. The second node 112, e.g., the API Server may do so instead.

### Signal Procedure

When the captivity state changes, specifically when it may be set to CAPTIVE in Action 406, the device 130, a UE, may need to be instructed to trigger interaction with the API Server. FIGS. 18 and 19 the two alternatives proposed to signal the device 130, a Server Push procedure in FIG. 18 and a Subscribe/Notify in FIG. 19.

FIG. 18 is a signalling diagram depicting a first non-limiting example of such a signal procedure as a Server Push. In Steps 1 and 2, when Captivity state is set to Captive, the second node 112, an API Server in this example, may trigger a signal towards the device 130. In order to do this, the API Server may trigger, according to Action 504, a Server Push message including the following parameters: CaptivityState=CAPTIVE, and UserPortalAddress=User Portal Instance Address.

FIG. 19 is a signalling diagram depicting another non-limiting example of a signal procedure as a Subscribe/Notify. In steps 1 and 2, the device 130, a UE, that is the OS of the UE OS, may check the captivity state with the second node 112, an API Server, and subscribe to updates on the captivity state. In order to do this, the device 130 may, in Step 2, trigger a subscribe message including the UE-ID and an indication to subscribe to updates on the captivity state, specifically when the captive state is set to Captive. In Step 3, the API Server may store the subscription information. In Steps 4 and 5, when the captivity state may be set to Captive, the API Server may trigger a signal towards the device 130, by generating a Notify message, including the following parameters: CaptivityState=CAPTIVE, and UserPortalAddress=User Portal Instance Address.

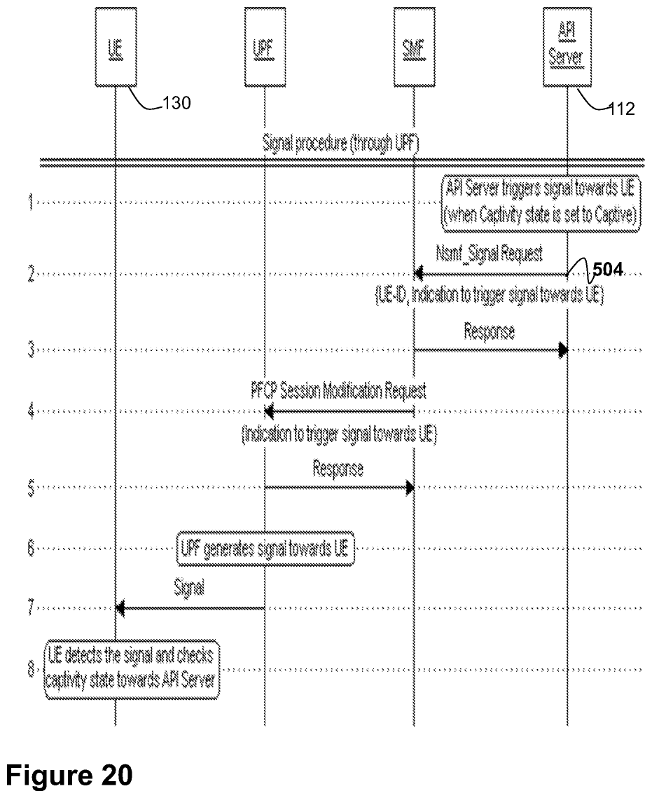

The above Signal procedures may use the existing connection between the device 130, that is, the OS of the device 130, and the second node 112, e.g., the API Server. FIG. 20 is a signalling diagram depicting a non-limiting example of another alternative, wherein the signal may be generated by the enforcement device, e.g., a UPF. In steps 1 and 2, when the Captivity state may be set to Captive, the API Server may trigger the signal procedure towards the device 130, in accordance with Action 504. In order to do this, the API Server may instruct the UPF to generate the signal, through the SMF, by generating a Nsmf_Signal Request message indicating the an identifier of the device 130, e.g., a UE-ID, and an indication to trigger the signal towards the device 130. The specific signal to be generated by the UPF may be assumed to be locally configured at the UPF, but it may also be possible that it may be conveyed as a parameter in the message in Step 2. In step 3, the SMF may answer the API Server indicating successful operation. In step 4, the SMF may forward the indication to the UPF by triggering a Packet Forwarding Control Protocol (PFCP) Session Modification Request message for the PFCP session for the UE-ID. In step 5, the UPF may answer the SMF indicating successful operation. In steps 6 and 7, the UPF may generate a signal towards may. In this example, it is assumed the specific signal message is locally configured at UPF. In step 8, the device 130 may detect the signal and may check the captivity state towards the API Server.

In all the procedures above, it may be assumed the API Server and the CAPPORT User portal are owned by the MNO. However, the API Server and the CAPPORT User portal may also be provided by a 3rd party, that may offer the service to the operators. All the above procedures may equally apply, with the following differences. A NEF may be involved in all interactions between the first core network node 111, e.g., 5G NFs and, the second node 112, e.g., the API Server and the third node 113, e.g., managing the CAPPORT User Portal. This may depend on the level of trust between the two business entities.

Certain embodiments disclosed herein may provide one or more of the following technical advantage(s), which may be summarized as follows.

As a first advantage, embodiments herein may be understood to allow a network operator to support user notification in a simple an effective way: the device 130, e.g., the OS of the device 130 may prompt the user and the notification cannot be missed.

As another advantage, embodiments herein may be understood to be based on IETF CAPPORT, which may be understood to solves a well-known problem of the interaction with CAPTIVE portals, which has motivated early adoption in UE OS. Android and iOS have some support and promote their implementation so as their future enhancement plans. Embodiments herein may be understood to involve only mobile network updates, which may simplify implementation and adoption.

As a further advantage, embodiments herein may be understood to not piggyback on the user traffic, as opposed to e.g., redirect. Therefore, embodiments herein may be understood to not be affected by traffic evolution, e.g., traffic encryption or new transport protocols. Embodiments herein may work when the user traffic may be encrypted, e.g., HTTPS/TLS, or with QUIC based applications. Embodiments herein may not be limited to certain applications, as opposed to e.g., redirect working only when using HTTP based applications.

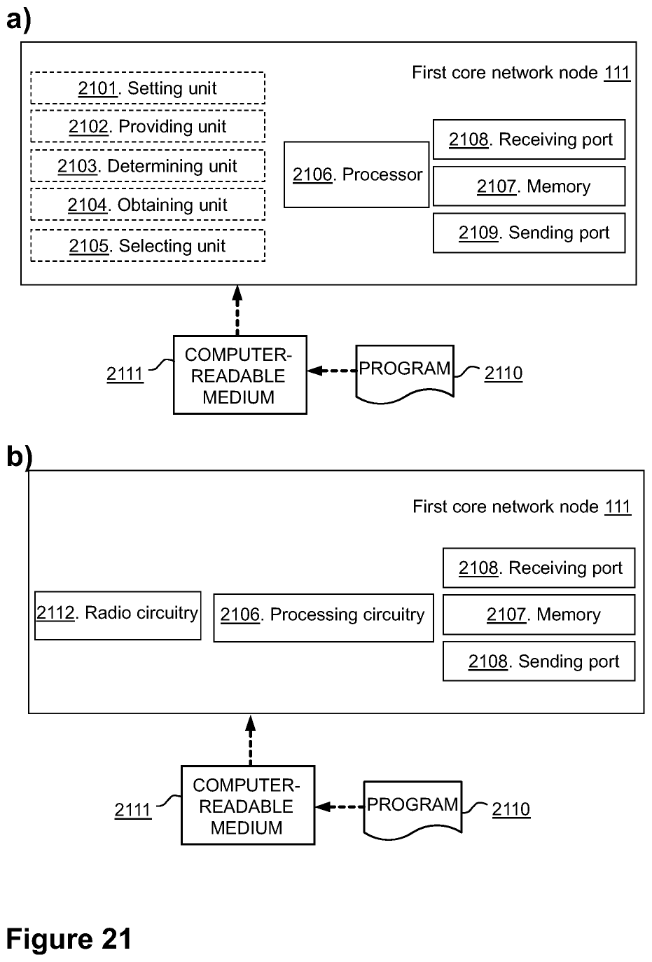

FIG. 21 depicts two different examples in panels a) and b), respectively, of the arrangement that the first core network node 111 may comprise to perform the method actions described above in relation to FIG. 4, and/or FIGS. 8-11, FIG. 13 and FIG. 15-17. In some embodiments, the first core network node 111 may comprise the following arrangement depicted in FIG. 21a. The first core network node 111 may be understood to be for handling performance of the action by the device 130. The first core network node 111 is configured to operate in the communications system 100. The device 130 is configured to operate in the communications system 100 via the connection through a data session.

Several embodiments are comprised herein. Components from one embodiment may be tacitly assumed to be present in another embodiment and it will be obvious to a person skilled in the art how those components may be used in the other exemplary embodiments. In FIG. 21, optional boxes are indicated by dashed lines. The detailed description of some of the following corresponds to the same references provided above, in relation to the actions described for the first core network node 111 and will thus not be repeated here. For example, the first core network node 111 may be configured to manage the data session.

The first core network node 111 is configured to, e.g. by means of a setting unit 2101 within the first core network node 111 configured to, set, based on a determination that the device 130 is to perform the action with the communications system 100, the captivity state of the device 130 to the captive state. The captive state is configured to indicate that the device 130 has not yet performed the action.

The first core network node 111 is also configured to, e.g. by means of a providing unit 2102 within the first core network node 111 configured to, provide the indication to the second node 112 configured to operate in the communications system 100. The second node 112 is configured to manage, via the first application programming interface, the third node 113 configured to operate in the communications system 100, The third node 113 is configured to manage the captivity portal accessible by the device 130 to perform the action. The indication is configured to indicate the state of the device 130 has been set to captive state for the action.

In some embodiments wherein the providing of the indication wherein the providing of the indication is configured to be performed via a first service-based interface configured to be performed via the first service-based interface, the first core network node 111 may be configured to, e.g. by means of a determining unit 2103 within the first core network node 111 configured to, determine that the device 130 is to perform the action.

The first core network node 111 may be further configured to, e.g. by means of the providing unit 2102 further configured to, provide the further indication configured to indicate the action determined to have to be performed by the device 130 via the captivity portal. The further indication may be configured to be provided to one of: a) the second node 112, via the first service-based interface, and b) the third node 113, via the second service-based interface.

In some embodiments, the first core network node 111 may be further configured to, e.g. by means of the determining unit 2103 further configured to, determine that the device 130 has performed the action via at least one of the captivity portal and another interface with the communications system 100.

In some embodiments, the first core network node 111 may be further configured to, e.g. by means of the providing unit 2102 further configured to, provide, after determining that the device 130 has performed the action, the another indication to the second node 112. The another indication is configured to indicate to the second node 112 to clear the captive state.

In some embodiments wherein the indication may be configured to be the fourth indication, the first core network node 111 may be configured to, e.g. by means of an obtaining 2104 within the first core network node 111 configured to, obtain the first indication that the second node 112 provides the first service enabling to notify the device 130 to perform the action via the captivity portal configured to be managed by the third node 113.

In some embodiments, the first core network node 111 may be further configured to, e.g. by means of the obtaining unit 2104 further configured to, obtain the second indication that the third node 113 provides the second service configured to enable to notify the device 130 to perform the action via the captivity portal configured to be managed by the third node 113.

In some embodiments wherein the indication may be configured to be the fourth indication, the first core network node 111 may be configured to, e.g. by means of a selecting 2105 within the first core network node 111 configured to, select at least one of the second node 112 and the third node 113 for the providing of the fourth indication, based on at least one of the first indication, and the second indication configured to be obtained.

In some embodiments, the first core network node 111 may be further configured to, e.g. by means of the obtaining unit 2104 further configured to, obtain the one or more third indications configured to identify at least one of: the second node 112, and the captivity portal via which the device 130 is to perform the action. The fourth indication may be configured to comprise at least one of the one or more third indications configured to be obtained.

In some embodiments, wherein the action may be configured to be one of the plurality of actions to be performed by the device 130, each of the actions may be configured to be performed by the device 130 via the respective captivity portal, and each respective captivity portal may be configured to be identifiable by the respective one or more third indications.

In some embodiments, the setting of the captivity state may be configured to comprise consolidating the plurality of actions into the single captivity state.

In some embodiments, the first core network node 111 may be configured to manage the data session, and the first core network node 111 may be configured to provide the one or more third indications to the device 130 configured to be obtained.

In some embodiments, at least two of the first core network node 111, the second node 112 and the third node 113 may be configured to be one of: co-localized and the same node.

The embodiments herein may be implemented through one or more processors, such as a processor 2106 in the first core network node 111 depicted in FIG. 21, together with computer program code for performing the functions and actions of the embodiments herein. The program code mentioned above may also be provided as a computer program product, for instance in the form of a data carrier carrying computer program code for performing the embodiments herein when being loaded into the in the first core network node 111. One such carrier may be in the form of a CD ROM disc. It is however feasible with other data carriers such as a memory stick. The computer program code may furthermore be provided as pure program code on a server and downloaded to the first core network node 111.

The first core network node 111 may further comprise a memory 2107 comprising one or more memory units. The memory 2107 is arranged to be used to store obtained information, store data, configurations, schedulings, and applications etc. to perform the methods herein when being executed in the first core network node 111.

In some embodiments, the first core network node 111 may receive information from, e.g., the second node 112, the third node 113, another core network node, the device 130, and/or another node through a receiving port 2108. In some examples, the receiving port 2108 may be, for example, connected to one or more antennas in the first core network node 111. In other embodiments, the first core network node 111 may receive information from another structure in the communications system 100 through the receiving port 2108. Since the receiving port 2108 may be in communication with the processor 2106, the receiving port 2108 may then send the received information to the processor 2106. The receiving port 2108 may also be configured to receive other information.

The processor 2106 in the first core network node 111 may be further configured to transmit or send information to e.g., the second node 112, the third node 113, another core network node, the device 130, another node, and/or another structure in the communications system 100, through a sending port 2109, which may be in communication with the processor 2106, and the memory 2107.

Those skilled in the art will also appreciate that any of the units 2101-2105 described above may refer to a combination of analog and digital circuits, and/or one or more processors configured with software and/or firmware, e.g., stored in memory, that, when executed by the one or more processors such as the processor 2106, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 2101-2105 described above may be the processor 2106 of the first core network node 111, or an application running on such processor.

Thus, the methods according to the embodiments described herein for the first core network node 111 may be respectively implemented by means of a computer program 2110 product, comprising instructions, i.e., software code portions, which, when executed on at least one processor 2106, cause the at least one processor 2106 to carry out the actions described herein, as performed by the first core network node 111. The computer program 2110 product may be stored on a computer-readable storage medium 2111. The computer-readable storage medium 2111, having stored thereon the computer program 2110, may comprise instructions which, when executed on at least one processor 2106, cause the at least one processor 2106 to carry out the actions described herein, as performed by the first core network node 111. In some embodiments, the computer-readable storage medium 2111 may be a non-transitory computer-readable storage medium, such as a CD ROM disc, a memory stick, or stored in the cloud space. In other embodiments, the computer program 2110 product may be stored on a carrier containing the computer program, wherein the carrier is one of an electronic signal, optical signal, radio signal, or the computer-readable storage medium 2111, as described above.

The first core network node 111 may comprise an interface unit to facilitate communications between the first core network node 111 and other nodes or devices, e.g., the second node 112, the third node 113, another core network node, the device 130, another node, and/or another structure in the communications system 100. In some particular examples, the interface may, for example, include a transceiver configured to transmit and receive radio signals over an air interface in accordance with a suitable standard.

In other embodiments, the first core network node 111 may comprise the following arrangement depicted in FIG. 21b. The first core network node 111 may comprise a processing circuitry 2106, e.g., one or more processors such as the processor 2106, in the first core network node 111 and the memory 2107. The first core network node 111 may also comprise a radio circuitry 2112, which may comprise e.g., the receiving port 2108 and the sending port 2109. The processing circuitry 2106 may be configured to, or operable to, perform the method actions according to FIG. 4, and/or FIGS. 8-11, FIG. 13 and FIG. 15-17, in a similar manner as that described in relation to FIG. 21a. The radio circuitry 2112 may be configured to set up and maintain at least a wireless connection with the second node 112, the third node 113, another core network node, the device 130, another node, and/or another structure in the communications system 100.

Hence, embodiments herein also relate to the first core network node 111 operative for handling performance of the action by the device 130, the first core network node 111 being operative to operate in the communications system 100. The device 130 being operative to operate in the communications system 100 via the connection through a data session. The first core network node 111 may comprise the processing circuitry 2106 and the memory 2107, said memory 2107 containing instructions executable by said processing circuitry 2106, whereby the first core network node 111 is further operative to perform the actions described herein in relation to the first core network node 111, e.g., in FIG. 4, and/or FIGS. 8-11, FIG. 13 and FIG. 15-17.

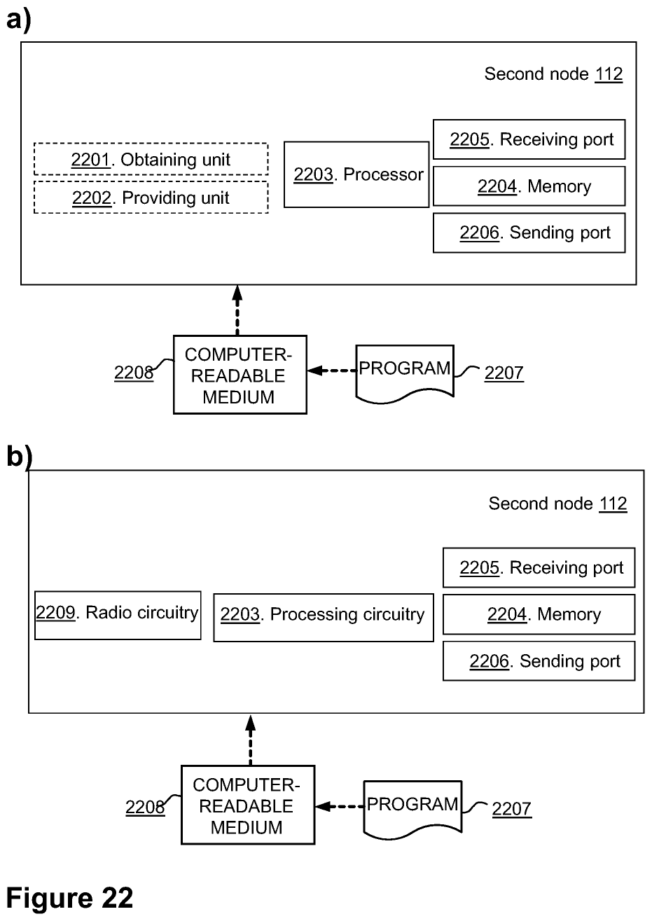

FIG. 22 depicts two different examples in panels a) and b), respectively, of the arrangement that the second node 112 may comprise to perform the method actions described above in relation to FIG. 5, and/or FIGS. 8-12, and/or FIG. 17-FIG. 20. In some embodiments, the second node 112 may comprise the following arrangement depicted in FIG. 22a. The second node 112 may be understood to be for handling the performance of the action by the device 130. The second node 112 is configured to operate in the communications system 100. The device 130 is configured to operate in the communications system 100 via the connection through the data session.

Several embodiments are comprised herein. Components from one embodiment may be tacitly assumed to be present in another embodiment and it will be obvious to a person skilled in the art how those components may be used in the other exemplary embodiments. In FIG. 22, optional boxes are indicated by dashed lines. The detailed description of some of the following corresponds to the same references provided above, in relation to the actions described for the second node 112 and will thus not be repeated here. For example, the first core network node 111 may be configured to manage the data session.

The second node 112 is configured to, e.g. by means of an obtaining unit 2201 within the second node 112 configured to, obtain the indication from the first core network node 111 configured to operate in the communications system 100. The second node 112 is configured to manage, via the first application programming interface. The third node 113 is configured to operate in the communications system 100. The third node 113 is configured to manage the captivity portal accessible by the device 130 to perform the action, the indication is configured to indicate the state of the device 130 has been set to captive state for the action. The captive state is configured to indicate that the device 130 has not yet performed the action.

The second node 112 is also configured to, e.g. by means of a providing unit 2202 within the second node 112 configured to, provide, based on the indication configured to be obtained, the additional indication to or towards the device 130. The additional indication is configured to indicate to the device 130 to contact the third node 113 to perform the action via the captivity portal.

In some embodiments wherein the additional indication may be configured to be the seventh indication, the second node 112 may be further configured to, e.g. by means of the obtaining unit 2201 within the second node 112 configured to, obtain the another indication from the first core network node 111. The another indication may be configured to indicate to the second node 112 to clear the captive state.

The second node 112 may also be configured to, e.g. by means of the providing unit 2202 within the second node 112 configured to, provide, to the third node 113 and based on the another indication configured to be obtained, the eighth indication configured to indicate to remove the action from the captivity portal.

In some embodiments wherein the indication configured to be obtained from the first core network node 111 may be configured to be the fourth indication, the second node 112 may be further configured to, e.g. by means of the providing unit 2202 within the second node 112 configured to, provide, to the another core network node 114, the first indication that the second node 112 may provide the first service enabling to notify the device 130 to perform the action via the captivity portal configured to be managed by the third node 113. The obtaining of the fourth indication may be configured to be based on the first indication configured to be provided.

In some embodiments wherein the indication configured to be obtained from the first core network node 111 may be configured to be the fourth indication, and wherein the fourth indication may be configured to comprise at least one of the one or more third indications configured to identify at least one of: the second node 112, and the captivity portal via which the device 130 is to perform the action, the second node 112 may be further configured to, e.g. by means of the providing unit 2202 within the second node 112 configured to, provide, to the third node 113, the first third indication of the one or more third indications configured to identify the captivity portal via which the device 130 is to perform the action.

In some embodiments, wherein the action may be configured to be one of the plurality of actions to be performed by the device 130, each of the actions may be configured to be performed by the device 130 via the respective captivity portal, and each respective captivity portal may be configured to be identifiable by the respective one or more third indications.

In some embodiments, the plurality of actions may be configured to be consolidated into the single captivity state.

In some embodiments, the obtaining of the indication may be configured to be performed via the first service-based interface.

In some embodiments, at least two of the first core network node 111, the second node 112 and the third node 113 may be configured to be one of: co-localized and the same node.

The embodiments herein may be implemented through one or more processors, such as a processor 2203 in the second node 112 depicted in FIG. 22, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 2204 comprising one or more memory units. The memory 2204 is arranged to be used to store obtained information, store data, configurations, schedulings, and applications etc. to perform the methods herein when being executed in the second node 112.

In some embodiments, the second node 112 may receive information from, e.g., the first core network node 111, the third node 113, another core network node, the device 130, and/or another node, through a receiving port 2205. In some examples, the receiving port 2205 may be, for example, connected to one or more antennas in the second node 112. In other embodiments, the second node 112 may receive information from another structure in the communications system 100 through the receiving port 2205. Since the receiving port 2205 may be in communication with the processor 2203, the receiving port 2205 may then send the received information to the processor 2203. The receiving port 2205 may also be configured to receive other information.

The processor 2203 in the second node 112 may be further configured to transmit or send information to e.g., the first core network node 111, the third node 113, another core network node, the device 130, another node and/or another structure in the communications system 100, through a sending port 2206, which may be in communication with the processor 2203, and the memory 2204.

Those skilled in the art will also appreciate that any of the units 2201-2202 described above may refer to a combination of analog and digital circuits, and/or one or more processors configured with software and/or firmware, e.g., stored in memory, that, when executed by the one or more processors such as the processor 2203, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 2201-2202 described above may be the processor 2203 of the second node 112, or an application running on such processor.

Thus, the methods according to the embodiments described herein for the second node 112 may be respectively implemented by means of a computer program 2207 product, comprising instructions, i.e., software code portions, which, when executed on at least one processor 2203, cause the at least one processor 2203 to carry out the actions described herein, as performed by the second node 112. The computer program 2207 product may be stored on a computer-readable storage medium 2208. The computer-readable storage medium 2208, having stored thereon the computer program 2207, may comprise instructions which, when executed on at least one processor 2203, cause the at least one processor 2203 to carry out the actions described herein, as performed by the second node 112. In some embodiments, the computer-readable storage medium 2208 may be a non-transitory computer-readable storage medium, such as a CD ROM disc, a memory stick, or stored in the cloud space. In other embodiments, the computer program 2207 product may be stored on a carrier containing the computer program, wherein the carrier is one of an electronic signal, optical signal, radio signal, or the computer-readable storage medium 2208, as described above.

The second node 112 may comprise an interface unit to facilitate communications between the second node 112 and other nodes or devices, e.g., the first core network node 111, the third node 113, another core network node, the device 130, another node and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 22b. The second node 112 may comprise a processing circuitry 2203, e.g., one or more processors such as the processor 2203, in the second node 112 and the memory 2204. The second node 112 may also comprise a radio circuitry 2209, which may comprise e.g., the receiving port 2205 and the sending port 2206. The processing circuitry 2203 may be configured to, or operable to, perform the method actions according to FIG. 5, and/or FIGS. 8-12, and/or FIG. 17-FIG. 20, in a similar manner as that described in relation to FIG. 22a. The radio circuitry 2209 may be configured to set up and maintain at least a wireless connection with the first core network node 111, the third node 113, another core network node, the device 130, another node and/or another structure in the communications system 100.

Hence, embodiments herein also relate to the second node 112 operative for verifying the second node 112 as the server for the application, the second node 112 being operative to operate in the communications system 100. The device 130 being operative to operate in the communications system 100 via the connection through a data session. The second node 112 may comprise the processing circuitry 2203 and the memory 2204, said memory 2204 containing instructions executable by said processing circuitry 2203, whereby the second node 112 is further operative to perform the actions described herein in relation to the second node 112, e.g., in FIG. 5, and/or FIGS. 8-12, and/or FIG. 17-FIG. 20.

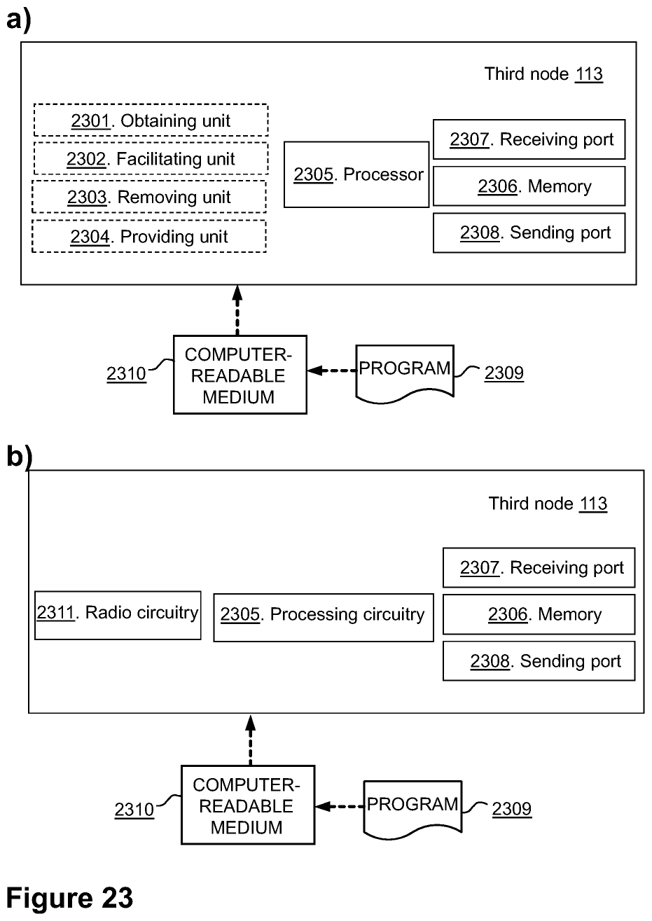

FIG. 23 depicts two different examples in panels a) and b), respectively, of the arrangement that the third node 113 may comprise to perform the method actions described above in relation to FIG. 6, FIGS. 8-11 and/or FIG. 14. In some embodiments, the third node 113 may comprise the following arrangement depicted in FIG. 23a. The third node 113 may be understood to be for handling the performance of the action by the device 130. The third node 113 is configured to operate in the communications system 100. The device 130 is configured to operate in the communications system 100 via the connection through the data session.

Several embodiments are comprised herein. Components from one embodiment may be tacitly assumed to be present in another embodiment and it will be obvious to a person skilled in the art how those components may be used in the other exemplary embodiments. In FIG. 23, optional boxes are indicated by dashed lines. The detailed description of some of the following corresponds to the same references provided above, in relation to the actions described for the third node 113 and will thus not be repeated here. For example, the first core network node 111 may be configured to manage the data session.

The third node 113 is configured to, e.g. by means of an obtaining unit 2301 within the third node 113 configured to, obtain the further indication from the first core network node 111 configured to operate in the communications system 100, the further indication configured to indicate the action to be performed by the device 130 via the captivity portal configured to be managed by the third node 113 and accessible by the device 130 to perform the action. The further indication is configured to be provided via the second service-based interface.

The third node 113 is also configured to, e.g. by means of a facilitating unit 2302 within the third node 113 configured to, facilitate, based on the further indication configured to be obtained, performance of the action by the device 130 via the captivity portal.

The third node 113 may be configured to, e.g. by means of the obtaining unit 2301 within the third node 113 configured to, obtain, from the second node 112 configured to operate in the communications system 100, the second node 112 being configured to manage the third node 113 via the first application programming interface, the eighth indication configured to indicate to remove the action from the captivity portal.

The third node 113 may be further configured to, e.g. by means of a removing unit 2303 within the third node 113 configured to, remove the action from the captivity portal, based on the eighth indication configured to be obtained.

The third node 113 may be further configured to, e.g. by means of a providing unit 2304 within the third node 113 configured to, provide, to the another core network node 114, the second indication that the third node 113 provides the second service enabling to notify the device 130 to perform the action via the captivity portal configured to be managed by the third node 113.

The third node 113 may be configured to, e.g. by means of the obtaining unit 2301 within the third node 113 configured to, obtain, from the second node 112, the first third indication configured to identify the captivity portal via which the device 130 is to perform the action.

In some embodiments, at least two of the first core network node 111, the second node 112 and the third node 113 may be configured to be one of: co-localized and the same node.

The embodiments herein may be implemented through one or more processors, such as a processor 2305 in the third node 113 depicted in FIG. 23, together with computer program code for performing the functions and actions of the embodiments herein. The program code mentioned above may also be provided as a computer program product, for instance in the form of a data carrier carrying computer program code for performing the embodiments herein when being loaded into the in the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 2306 comprising one or more memory units. The memory 2306 is arranged to be used to store obtained information, store data, configurations, schedulings, and applications etc. to perform the methods herein when being executed in the third node 113.

In some embodiments, the third node 113 may receive information from, e.g., the first core network node 111, the second node 112, another core network node, the device 130, and/or another node, through a receiving port 2307. In some examples, the receiving port 2307 may be, for example, connected to one or more antennas in the third node 113. In other embodiments, the third node 113 may receive information from another structure in the communications system 100 through the receiving port 2307. Since the receiving port 2307 may be in communication with the processor 2305, the receiving port 2307 may then send the received information to the processor 2305. The receiving port 2307 may also be configured to receive other information.

The processor 2305 in the third node 113 may be further configured to transmit or send information to e.g., the first core network node 111, the second node 112, another core network node, the device 130, another node, and/or another structure in the communications system 100, through a sending port 2308, which may be in communication with the processor 2305, and the memory 2306.

Those skilled in the art will also appreciate that the units 2301-2304 described above may refer to a combination of analog and digital circuits, and/or one or more processors configured with software and/or firmware, e.g., stored in memory, that, when executed by the one or more processors such as the processor 2305, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 2301-2304 described above may be the processor 2305 of the third node 113, or an application running on such processor.

Thus, the methods according to the embodiments described herein for the third node 113 may be respectively implemented by means of a computer program 2309 product, comprising instructions, i.e., software code portions, which, when executed on at least one processor 2305, cause the at least one processor 2305 to carry out the actions described herein, as performed by the third node 113. The computer program 2309 product may be stored on a computer-readable storage medium 2310. The computer-readable storage medium 2310, having stored thereon the computer program 2309, may comprise instructions which, when executed on at least one processor 2305, cause the at least one processor 2305 to carry out the actions described herein, as performed by the third node 113. In some embodiments, the computer-readable storage medium 2310 may be a non-transitory computer-readable storage medium, such as a CD ROM disc, a memory stick, or stored in the cloud space. In other embodiments, the computer program 2309 product may be stored on a carrier containing the computer program, wherein the carrier is one of an electronic signal, optical signal, radio signal, or the computer-readable storage medium 2310, as described above.

The third node 113 may comprise an interface unit to facilitate communications between the third node 113 and other nodes or devices, e.g., the first core network node 111, the second node 112, another core network node, the device 130, another node, and/or another structure in the communications system 100. In some particular examples, the interface may, for example, include a transceiver configured to transmit and receive radio signals over an air interface in accordance with a suitable standard.

In other embodiments, the third node 113 may comprise the following arrangement depicted in FIG. 23b. The third node 113 may comprise a processing circuitry 2305, e.g., one or more processors such as the processor 2305, in the third node 113 and the memory 2306. The third node 113 may also comprise a radio circuitry 2311, which may comprise e.g., the receiving port 2307 and the sending port 2308. The processing circuitry 2305 may be configured to, or operable to, perform the method actions according to FIG. 6, FIGS. 8-11 and/or FIG. 14, in a similar manner as that described in relation to FIG. 23a. The radio circuitry 2311 may be configured to set up and maintain at least a wireless connection with the first core network node 111, the second node 112, another core network node, the device 130, another node, and/or another structure in the communications system 100.

Hence, embodiments herein also relate to the third node 113 operative for verifying the second node 112 as the server for the application, the third node 113 being operative to operate in the communications system 100. The device 130 being operative to operate in the communications system 100 via the connection through a data session. The third node 113 may comprise the processing circuitry 2305 and the memory 2306, said memory 2306 containing instructions executable by said processing circuitry 2305, whereby the third node 113 is further operative to perform the actions described herein in relation to the third node 113, e.g., in FIG. 6, FIGS. 8-11 and/or FIG. 14.

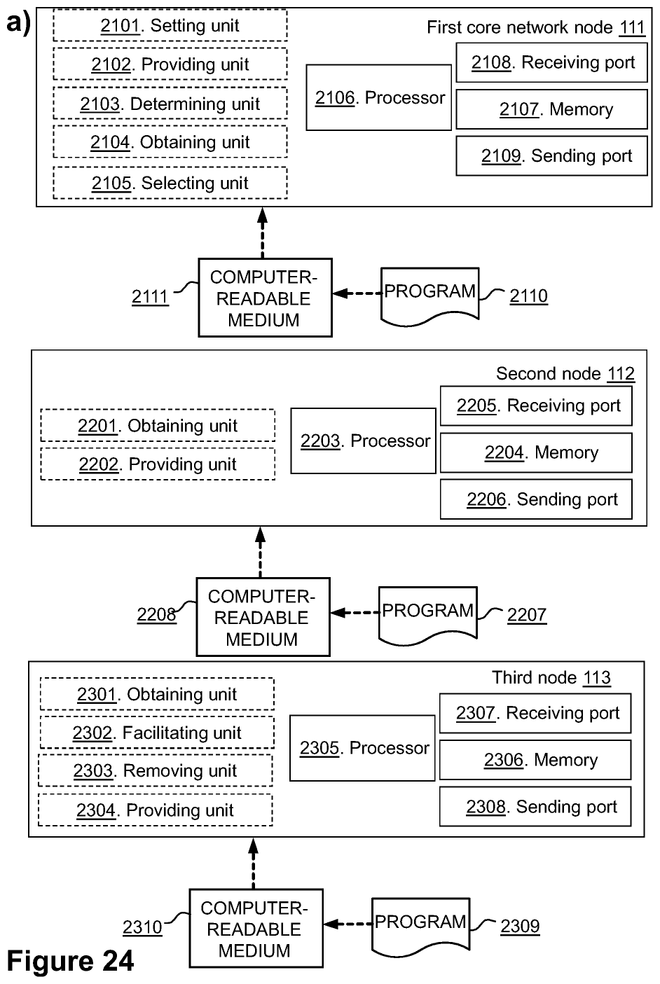

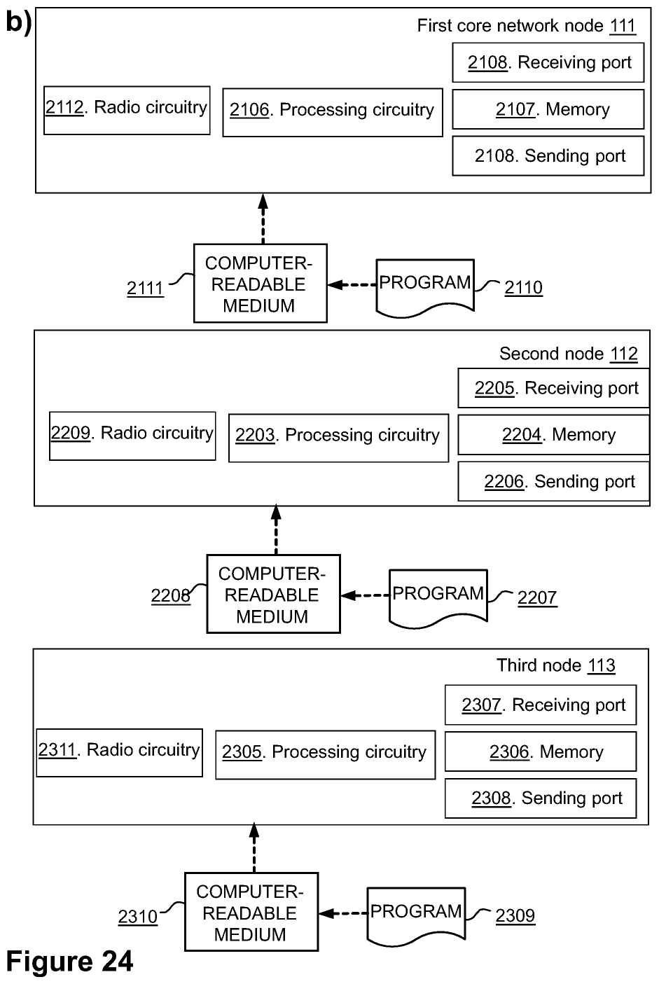

FIG. 24 depicts two different examples in panels a) and b), respectively, of the arrangement that the communications system 100 may comprise to perform the method actions described above in relation to FIG. 7, and/or any of FIGS. 8-20. The arrangement depicted in panel a) corresponds to that described in relation to panel a) in FIG. 21, FIG. 22 and FIG. 23 for each of the first core network node 111, the second node 112 and the third node 113, respectively. The arrangement depicted in panel b) corresponds to that described in relation to panel b) in FIG. 21, FIG. 22 and FIG. 23 for each of the first core network node 111, the second node 112 and the third node 113, respectively. The communications system 100 may be for handling the performance of the action by the device 130. The communications system 100 is configured to comprise the first core network node 111, the second node 112 and the third node 113.

The communications system 100 is configured to, e.g. by means of the setting unit 2101 within the first core network node 111 configured to, set, by the first core network node 111, based on the determination that the device 130 is to perform the action with the communications system 100, the captivity state of the device 130 to the captive state, the captive state being configured to indicate that the device 130 has not yet performed the action.

The communications system 100 is also configured to, e.g. by means of the providing unit 2102 within the first core network node 111 configured to, provide, by the first core network node 111, the indication to the second node 112. The second node 112 is configured to manage, via the first application programming interface, the third node 113 configured to operate in the communications system 100. The third node 113 is configured to manage the captivity portal accessible by the device 130 to perform the action. The indication is configured to indicate the state of the device 130 has been set to captive state for the action.

The communications system 100 is configured to, e.g. by means of the obtaining unit 2201 within the second node 112 configured to, obtain, by the second node 112, the indication from the first core network node 111, the captive state being configured to indicate that the device 130 has not yet performed the action.

The communications system 100 is also configured to, e.g. by means of the providing unit 2202 within the second node 112 configured to, provide, by the second node 112, based on the indication configured to be obtained, the additional indication to or towards the device 130, the additional indication being configured to indicate to the device 130 to contact the third node 113 to perform the action via the captivity portal.

The communications system 100 is configured to, e.g. by means of the obtaining unit 2301 within the third node 113 configured to, obtain, by the third node 113, the a further indication from the first core network node 111, the further indication being configured to indicate the action to be performed by the device 130 via the captivity portal configured to be managed by the third node 113 and accessible by the device 130 to perform the action, wherein the further indication is configured to be provided via the second service-based interface.

The communications system 100 is also configured to, e.g. by means of the facilitating unit 2302 within the third node 113 configured to, facilitate, by the third node 113, based on the further indication configured to be obtained, performance of the action by the device 130 via the captivity portal.

In some embodiments wherein the providing of the indication may be configured to be performed via the first service-based interface, the communications system 100 may be further configured to, the communications system 100 may be configured to, e.g. by means of the determining unit 2103 within the first core network node 111 configured to, determine, by the first core network node 111, that the device 130 is to perform the action.

In some embodiments, the communications system 100 may be configured to, e.g. by means of the providing unit 2102 within the first core network node 111 configured to, provide, by the first core network node 111, the further indication being configured to indicate the action determined to have to be performed by the device 130 via the captivity portal, wherein the further indication may be configured to be provided to one of: a) the second node 112, via the first service-based interface, and b) the third node 113, via the second service-based interface.

The communications system 100 may be further configured to, e.g. by means of the determining unit 2103 within the first core network node 111 further configured to, determine, by the first core network node 111, that the device 130 has performed the action via at least one of the captivity portal and another interface with the communications system 100.

The communications system 100 is configured to, e.g. by means of the providing unit 2102 within the first core network node 111 configured to, provide, by the first core network node 111, after determining that the device 130 has performed the action, another indication to the second node 112, the another indication being configured to indicate to the second node 112 to clear the captive state, wherein the additional indication may be configured to be the seventh indication.

In some embodiments, the communications system 100 may be further configured to, e.g. by means of the obtaining unit 2201 within the second node 112 further configured to, obtain, by the second node 112, another indication from the first core network node 111, the another indication being configured to indicate to the second node 112 to clear the captive state.

In some embodiments, the communications system 100 may be further configured to, e.g. by means of the providing unit 2202 within the second node 112 further configured to, provide, by the second node 112, to the third node 113 and based on the obtained another indication, the eighth indication configured to indicate to remove the action from the captivity portal.

In some embodiments, the communications system 100 may be further configured to, e.g. by means of the obtaining unit 2301 within the third node 113 further configured to, obtain, by the third node 113, from the second node 112, the eighth indication.

In some embodiments, the communications system 100 may be further configured to, e.g. by means of the removing unit 2304 within the third node 113 further configured to, remove, by the third node 113, the action from the captivity portal, based on the eighth indication configured to be obtained.

In some embodiments wherein the indication may be configured to be the fourth indication, the communications system 100 may be further configured to, e.g. by means of the providing unit 2202 within the second node 112 further configured to, provide, by the second node 112, to the another core network node 114, the first indication that the second node 112 provides the first service configured to enable to notify the device 130 to perform the action via the captivity portal configured to be managed by the third node 113, and the obtaining of the fourth indication may be configured to be based on the first indication configured to be provided.

The communications system 100 is configured to, e.g. by means of the obtaining unit 2104 within the first core network node 111 configured to, obtain, by the first core network node 111, the first indication that the second node 112 provides the first service configured to enable to notify the device 130 to perform the action via the captivity portal configured to be managed by the third node 113.

In some embodiments, the communications system 100 may be further configured to, e.g. by means of the providing unit 2304 within the third node 113 further configured to, provide, by the third node 113, to the another core network node 114, the second indication that the third node 113 provides the second service configured to enable to notify the device 130 to perform the action via the captivity portal configured to be managed by the third node 113.

The communications system 100 is configured to, e.g. by means of the obtaining unit 2104 within the first core network node 111 configured to, obtain, by the first core network node 111, the second indication.

The communications system 100 is configured to, e.g. by means of the selecting unit 2105 within the first core network node 111 configured to, select, by the first core network node 111, at least one of the second node 112 and the third node 113 for the providing of the fourth indication, based on at least one of the first indication, and the second indication configured to be obtained.

The communications system 100 is configured to, e.g. by means of the obtaining unit 2104 within the first core network node 111 configured to, obtain, by the first core network node 111, the one or more third indications configured to identify at least one of: the second node 112, and the captivity portal via which the device 130 is to perform the action, and wherein the fourth indication may be configured to comprise at least one of the one or more third indications configured to be obtained.

In some embodiments, wherein the action may be configured to be one of the plurality of actions to be performed by the device 130, each of the actions may be configured to be performed by the device 130 via the respective captivity portal, and each respective captivity portal may be configured to be identifiable by the respective one or more third indications.

In some embodiments, the setting of the captivity state may be configured to comprise consolidating the plurality of actions into the single captivity state.

In some embodiments, the first core network node 111 may be configured to manage the data session, and the first core network node 111 may be configured to provide the one or more third indications to the device 130 configured to be obtained.

In some embodiments, at least two of the first core network node 111, the second node 112 and the third node 113 may be configured to be one of: co-localized and the same node.

In some embodiments, the obtaining of the indication by the second node 112 may be configured to be performed via the first service-based interface.

In some embodiments wherein the indication configured to be obtained from the first core network node 111 may be configured to be the fourth indication, and wherein the fourth indication may be configured to comprise at least one of one or more third indications configured to identify at least one of: the second node 112, and the captivity portal via which the device 130 is to perform the action, the communications system 100 may be further configured to, e.g. by means of the providing unit 2202 within the second node 112 configured to, provide, by the second node 112, to the third node 113, the first third indication of the one or more third indications configured to identify the captivity portal via which the device 130 is to perform the action.

In some embodiments, the communications system 100 may be further configured to, e.g. by means of the obtaining unit 2301 within the third node 113 further configured to, obtain, by the third node 113, from the second node 112, the first third indication.

The remaining configurations described for the first core network node 111, the second node 112 and the third node 113 in relation to FIG. 24, may be understood to correspond to those described in FIG. 21, FIG. 22 and FIG. 23, respectively, and to be performed, e.g., by means of the corresponding units and arrangements described in FIG. 21, FIG. 22 and FIG. 23, which will not be repeated here.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. IETF RFC 8952: Captive Portal Architecture
2. IETF RFC 8908: Captive Portal API
3. IETF RFC 8910: Captive Portal Identification in DHCP and Router Advertisements

1. A computer-implemented method, performed by a first core network node, for handling performance of an action by a device, the first core network node operating in a communications system, and the device operating in the communications system via a connection through a data session, the method comprising:
setting, based on a determination that the device is to perform an action with the communications system, a captivity state of the device to a captive state, the captive state indicating that the device has not yet performed the action, and
providing an indication to a second node operating in the communications system, the second node managing, via a first application programming interface, a third node operating in the communications system, the third node managing a captivity portal accessible by the device to perform the action, the indication indicating the state of the device has been set to captive state for the action.

2. The computer-implemented method according to claim 1, wherein the providing of the indication is performed via a first service-based interface, and wherein the method further comprises:
determining that the device is to perform the action, and
providing a further indication indicating the action determined to have to be performed by the device via the captivity portal, wherein the further indication is provided to one of
the second node, via the first service-based interface, and
the third node, via a second service-based interface.

3. The computer-implemented method according to claim 1, wherein the method further comprises:
determining that the device has performed the action via at least one of the captivity portal and another interface with the communications system, and
providing, after determining that the device has performed the action, another indication to the second node, the another indication indicating to the second node to clear the captive state.

4. The computer-implemented method according to claim 1, wherein the indication is a fourth indication, and wherein the method further comprises:
obtaining a first indication that the second node provides a first service enabling to notify the device to perform the action via the captivity portal managed by the third node,
obtaining a second indication that the third node provides a second service enabling to notify the device to perform the action via the captivity portal managed by the third node, and
selecting at least one of the second node and the third node for the providing of the fourth indication, based on at least one of the obtained first indication, and the second indication.

5. The computer-implemented method according to claim 4, wherein the method further comprises:
obtaining one or more third indications identifying at least one of the second node, and the captivity portal via which the device is to perform the action, and wherein the fourth indication comprises at least one of the obtained one or more third indications.

6. The computer-implemented method according to claim 5, wherein the action is one of a plurality of actions to be performed by the device, wherein each of the actions is to be performed by the device via a respective captivity portal, and wherein each respective captivity portal is identifiable by respective one or more third indications.

7. The computer-implemented method according to claim 6, wherein the setting of the captivity state comprises consolidating the plurality of actions into a single captivity state.

8. The computer-implemented method according to claim 5, wherein the first core network node manages the data session, and wherein the first core network node provides the obtained one or more third indications to the device.

9. The computer-implemented method according to claim 1, wherein at least two of the first core network node, the second node and the third node are one of: co-localized and the same node.

10. A computer-implemented method, performed by a second node, for handling performance of an action by a device, the second node operating in a communications system, and the device operating in the communications system via a connection through a data session, the method comprising:
obtaining an indication from a first core network node operating in the communications system, the second node managing, via a first application programming interface, a third node operating in the communications system, the third node managing a captivity portal accessible by the device to perform the action, the indication indicating the state of the device has been set to captive state for the action, the captive state indicating that the device has not yet performed the action, and
providing, based on the obtained indication, an additional indication to or towards the device, the additional indication indicating to the device to contact the third node to perform the action via the captivity portal.

11. The computer-implemented method according to claim 10, wherein the additional indication is a seventh indication, and wherein the method further comprises:
obtaining another indication from the first core network node, the another indication indicating to the second node to clear the captive state, and providing, to the third node and based on the obtained another indication, an eighth indication indicating to remove the action from the captivity portal.

12. The computer-implemented method according to claim 10, wherein the indication obtained from the first core network node is a fourth indication, and wherein the method further comprises:
providing, to another core network node, a first indication that the second node provides a first service enabling to notify the device to perform the action via the captivity portal managed by the third node, and wherein the obtaining of the fourth indication is based on the provided first indication.

13. The computer-implemented method according to claim 10, wherein the indication obtained from the first core network node is a fourth indication, and wherein the fourth indication comprises at least one of one or more third indications identifying at least one of the second node, and the captivity portal via which the device is to perform the action, and wherein the method further comprises:
providing, to the third node, a first third indication of the one or more third indications identifying the captivity portal via which the device is to perform the action.

14. The computer-implemented method according to claim 13, wherein the action is one of a plurality of actions to be performed by the device, wherein each of the actions is to be performed by the device via a respective captivity portal, and wherein each respective captivity portal is identifiable by respective one or more third indications.

15. The computer-implemented method according to claim 14, wherein the plurality of actions is consolidated into a single captivity state.

16. The computer-implemented method according to claim 10, wherein the first core network node manages the data session.

17. The computer-implemented method according to claim 10, wherein the obtaining of the indication is performed via a first service-based interface.

18. The computer-implemented method according to claim 10, wherein at least two of the first core network node, the second node and the third node are one of: co-localized and the same node.

19. A computer-implemented method, performed by a third node, for handling performance of an action by a device, the third node operating in a communications system, and the device operating in the communications system via a connection through a data session, the method comprising:
obtaining a further indication from a first core network node operating in the communications system, a further indication indicating the action to be performed by the device via a captivity portal managed by the third node and accessible by the device to perform the action, wherein the further indication is provided via a second service-based interface, and
facilitating, based on the obtained further indication, performance of the action by the device via the captivity portal.

20. The computer-implemented method according to claim 19, wherein the method further comprises:
obtaining, from a second node operating in the communications system, the second node managing the third node via a first application programming interface, an eighth indication indicating to remove the action from the captivity portal, and
removing the action from the captivity portal, based on the obtained eighth indication.

21. The computer-implemented method according to claim 19, wherein the method further comprises:
providing, to another core network node, a second indication that the third node provides a second service enabling to notify the device to perform the action via the captivity portal managed by the third node.

22. The computer-implemented method according claim 19, wherein the method further comprises:
obtaining, from the second node, a first third indication identifying the captivity portal via which the device is to perform the action.

23. The computer-implemented method according to claim 19, wherein the first core network node manages the data session.

24. The computer-implemented method according to claim 19, wherein at least two of the first core network node, the second node and the third node are one of: co-localized and the same node.

25.-35. (canceled)

36. A first core network node, for handling performance of an action by a device, the first core network node being configured to operate in a communications system, and the device being configured to operate in the communications system via a connection through a data session, the first core network node being further configured to:
set, based on a determination that the device is to perform an action with the communications system, a captivity state of the device to a captive state, the captive state being configured to indicate that the device has not yet performed the action, and
provide an indication to a second node configured to operate in the communications system, the second node being configured to manage, via a first application programming interface, a third node configured to operate in the communications system, the third node being configured to manage a captivity portal accessible by the device to perform the action, the indication being configured to indicate the state of the device has been set to captive state for the action.

37.-70. (canceled)
